(19) United States
(12) Patent Application Publication
(10) Pub. No.: US 2022/0351273 A1
(43) Pub. Date: Nov. 3, 2022

(54) INTEGRATED SMART SHOPPING CART OPERATION METHOD AND SYSTEM FOR INTEGRATING AND OPERATING PLURALITY OF ONLINE SHOPPING MALL CARTS

(71) Applicant: Jeoungmin LEE, Seoul (KR)

(72) Inventor: Jeoungmin LEE, Seoul (KR)

(21) Appl. No.: 17/623,458

(22) PCT Filed: Jun. 24, 2020
(86) PCT No.: PCT/KR2020/008217

§ 371 Date: Dec. 28, 2021

(30) Foreign Application Priority Data
Jun. 28, 2019 (KR) 10-2019-0078101
Jun. 4, 2020 (KR) 10-2020-0067625

(51) Int. Cl. G06Q 30/06; G06F 3/04817; G06Q 20/22; G06Q 20/32; G06F 3/04842

(52) U.S. Cl. CPC G06Q 30/0633; G06F 3/04817; G06Q 20/2295; G06Q 30/0641; G06Q 20/3267; G06F 3/04842

(57) ABSTRACT

A method for operating an integrated smart shopping cart app using autonomous payments, includes: a step in which an integrated smart shopping cart icon is displayed through an online/mobile shopping mall app program driven in a first server, the integrated smart shopping cart icon is clicked and activated by a purchase requester, purchase information about the purchase by the purchase requester is transmitted from the first server to an integrated smart shopping cart app driving program of a second server, and a payment is made in the integrated smart shopping cart app on the basis of the purchase information by a payment right holder who is different from the purchase requester, or a step in which a payment is made by a payment right holder who is different from the purchase requester through an app driving program operated in the first server.

### CROSS-REFERENCE TO PRIOR APPLICATIONS

This application is a National Stage Patent Application of PCT International Patent Application No. PCT/KR2020/008217 (filed on Jun. 24, 2020) under 35 U.S.C. § 371, which claims priority to Korean Patent Application Nos. 10-2019-0078101 (filed on Jun. 28, 2019) and 10-2020-0067625 (filed on Jun. 4, 2020), which are all hereby incorporated by reference in their entirety.

### BACKGROUND

The present invention relates to an e-commerce method through online and mobile devices, and more particularly, to an integrated smart shopping cart operation method and a system for integrating, operating, and managing product information, payment information, and delivery information in a plurality of online shopping malls of a purchaser terminal, when a purchaser terminal equipped with an integrated smart shopping cart application program accesses a plurality of online shopping malls including a mobile shopping mall to select and pay for a product.

Currently, online shopping malls including mobile shopping malls (hereinafter referred to as online shopping malls) can be broadly divided into portal site shopping malls, collective shopping malls, specialized/individual shopping malls, SNS shopping malls that can give gifts to others, telecommunication company affiliated shopping mall markets, and the like.

In such an online shopping mall, there is a limitation in that product purchasers must provide their own personal information even if they individually subscribe in each shopping mall site, or purchase products with at least a non-member status. Accordingly, there is a problem in that the online shopping mall cannot efficiently provide product purchase to a child or adolescent who is a minor.

In addition, when purchasing a product, the product purchaser has an inconvenience of accessing the corresponding online shopping mall site and repeatedly performing the same actions necessary for ordering the product, such as inputting the product recipient, contact information, and delivery address. At the same time, when a product purchaser purchases products from a plurality of distributed online shopping mall sites instead of a single online shopping mall site, there is a hassle in that the purchase information and delivery information can be checked only after searching and re-accessing the corresponding online shopping mall site. In addition, when purchasing products in distributed online shopping malls, it is difficult to recognize and manage purchase points because the purchase points obtained at the time of purchasing a product are distributed in respective online shopping malls, and there is a problem in that it is difficult to use the purchase points efficiently.

On the other hand, when a minor wants to purchase a product by requesting a parent, the minor can check the purchase information and delivery information only by accessing the online shopping mall site ordered by the parent. However, it is not easy for the minor to access the online shopping mall site ordered by his/her parent. Due to these various problems, the current online shopping mall has a lot of room for improvement in terms of its use and utilization.

### SUMMARY

An object to be achieved by the present invention is to provide an integrated smart shopping cart operation method and an integrated smart shopping cart operation system therefor in which a purchaser terminal can access a plurality of online shopping malls including mobile shopping malls and product orders in the plurality of online shopping malls are integrated and paid by using integrated shopping carts in order to increase a product purchase rate while solving the above problems.

According to an aspect of the present invention, there is provided a method of operating an integrated smart shopping cart operation for integrating and operating a plurality of shopping mall shopping carts when an online/mobile shopping mall app and an integrated smart shopping cart app are installed in a first terminal of a purchase requester, and the integrated smart shopping cart app is installed in a second terminal of a payment right holder, the method including: preparing a driving program of the online/mobile shopping mall app in which an integrated smart shopping cart icon is displayed, in a first server; preparing an integrated smart shopping cart app driving program which connects to the first server to process the integrated smart shopping cart icon, in a second server; selecting a purchase product by the first terminal of the purchase requester connected to the online/mobile shopping mall app of the first server; activating the integrated smart shopping cart app driving program by activating the integrated smart shopping cart icon on a screen where the purchase product is selected in the first terminal; transmitting, to the second server, purchase product information and payment right holder information selected in the integrated smart shopping cart app of the first terminal; registering the purchase product information in a database of the second server; requesting, by the integrated smart shopping cart app driving program, to make a payment to the second terminal of the payment right holder selected based on the purchase product information; proceeding, by the second terminal of the payment right holder, a payment based on the registered purchase product information in the integrated smart shopping cart app to generate purchase information including delivery address information in the database; transmitting, by the integrated smart shopping cart app driving program, the purchase information and payment information to the online/mobile shopping mall app of the first server; transmitting, by the driving program of the online/mobile shopping mall app, delivery information for purchase information to the integrated smart shopping cart app driving program; and accessing, by the first and second terminals, to the integrated smart shopping cart app of the second server to check the payment/delivery information.

A method of displaying the integrated smart shopping cart icon in the online/mobile shopping mall app of the first server is one of methods selected from an icon form on an integrated smart shopping cart that pops up on the display screen for product purchase and a menu form on an integrated smart shopping cart newly generated on the display screen for purchase

The first terminal of the purchase requester is in a state where the integrated smart shopping cart app is installed and membership subscription is completed.

A method for subscribing as a member of the integrated smart shopping cart app includes generating an ID of a product purchaser who is the purchase requester; and designating a payment right holder for a purchase product from among members subscribed in the integrated smart shopping cart app or designating a payment right holder for the purchase product by using a portable phone number stored in the first terminal.

A method for activating the integrated smart shopping cart icon includes clicking an integrated smart shopping cart icon on an individual product display screen of the online/mobile shopping mall of the first server.

The method may further include designating, by the payment right holder, a proxy payer in the integrated smart shopping cart app before the step of proceeding the payment based on the registered purchase information by the payment right holder using the second terminal.

A method of proceeding, by the payment right holder using the second terminal, the payment based on the registered purchase information includes making the payment selectively or all at once based on the purchase product information selected by the purchase requester and the purchase information directly selected by the payment right holder.

The method may further include proceeding a purchase decision procedure in the integrated smart shopping cart app, after the step of accessing, by the first and second terminals, to the integrated smart shopping cart app of the second server to check the payment/delivery information; and providing an integration point for the payment right holder in the integrated smart shopping cart app.

In order to solve the technical problems of the present invention, according to another aspect of the present invention, there is provided a system of operating an integrated smart shopping cart, the system including: a plurality of first servers providing shopping mall service; a second server providing payment service by integrating payment requests for products purchased in the plurality of shopping mall servers; and a purchaser terminal which is equipped with an integrated smart shopping cart app, is configured to be able to access the plurality of first servers, and is configured to request a payment by selecting products to be purchased in the plurality of shopping malls, wherein, when at least one product to be purchased is selected in at least one shopping mall and the integrated smart shopping cart app is activated for payment, the integrated shopping cart app transmits, to the second server, payment right holder information input from a user or preset payment right holder information, and purchase product information on at least one selected product, and wherein, when receiving the payment right holder information and the purchase product information, the second server transmits the purchase product information to the payment right holder terminal to request a payment, and when the payment is made by the payment right holder terminal approving the payment, payment information for the purchase product information is transmitted to the first server corresponding to the paid product and the integrated smart shopping cart app.

When receiving the payment information for the paid product from the second server, the first server transmits delivery information for the paid product to the integrated smart shopping cart app.

In order to solve the technical problems of the present invention, according to another aspect of the present invention, there is provided a method of operating an integrated smart shopping cart in an online shopping mall, the method including: providing an online shopping mall platform, by an online shopping mall platform server which is configured to select, in one shopping mall, products sold in a plurality of online shopping malls respectively provided by a plurality of shopping mall servers and request a payment thereof; accessing, by a purchaser terminal, the online shopping mall platform; displaying an integrated smart shopping cart icon on a purchaser terminal screen when the purchaser terminal selects and pays for at least one product in the online shopping mall platform; transmitting purchase product information to be paid to the online shopping mall platform server when an integrated shopping cart icon displayed on the terminal screen is touched or clicked upon payment; and making a payment for the purchase product and transmitting payment information to a shopping mall server corresponding to the paid product when the online shopping mall platform server receives the purchase product information.

According to another aspect of the present invention, the method may further include: requesting an integrated payment to the online shopping mall platform server for the selected products by designating a payment right holder for the selected product or in a state where a payment right holder has already been designated, when the purchaser terminal selects a product to be purchased in the online shopping mall platform and touches or clicks an integrated smart shopping cart icon displayed on a terminal screen to pay directly or pay after putting the product in the shopping cart; transmitting the purchaser information and purchase product information to the payment right holder terminal when the online shopping mall platform server receives the payment right holder information and the purchase product information; receiving, by the payment right holder terminal, a payment request for the purchaser information and the purchase product information and approving a payment; and transmitting, by the online shopping mall platform server, the payment information to a shopping mall server corresponding to the paid product when payment for the purchase product corresponding to the payment approval by the payment right holder terminal is made.

When receiving a payment request for a plurality of purchase products from the online shopping mall platform server, the payment right holder terminal approves only a part of the payment for the plurality of purchase products, or designates a proxy payer.

When payment for the purchase product is made, the online shopping mall platform server transmits the payment information to an integrated smart shopping cart app equipped in the purchaser terminal and the payment right holder terminal.

According to another aspect of the present invention, the method may further include: proceeding a delivery of the purchase product and transmitting delivery information to the integrated smart shopping cart app equipped in the purchaser terminal and the payment right holder terminal when the shopping mall server receives payment information for the purchase product from the online shopping mall platform server.

According to another aspect of the present invention, the method may further include: providing an integrated point to the purchaser or payment right holder who has made the payment by the online shopping mall platform server when the payment for the purchase product is made.

The purchaser terminal selects the integrated smart shopping cart icon and links the product selected in the online shopping mall platform to the integrated smart shopping cart app, and then personal information is shared along with the purchase product information for the integrated smart shopping cart app member who permits information disclosure.

After product purchase is confirmed in the integrated smart shopping cart app, product information including product reviews, ID, region, gender, and age information left by the purchaser of the purchase terminal is classified and registered as a purchase list for each product on an integrated smart shopping cart app screen.

In order to solve the technical problems of the present invention, according to another aspect of the present invention, there is provided a system of operating an integrated smart shopping cart, the system including: an online shopping mall platform configured to select and purchase, in one shopping mall, products sold in a plurality of online shopping malls provided by a plurality of online shopping mall servers; an integrated smart shopping cart application that provides payment service by integrating payment requests for a plurality of shopping mall products selected in the online shopping mall platform; an online shopping mall platform server that provides the online shopping mall platform and the integrated smart shopping cart application; and a purchaser terminal configured to be equipped with an integrated smart shopping cart app or installed with integrated smart shopping cart software, to access the online shopping mall platform through the integrated smart shopping cart app or the integrated smart shopping cart software, to select a plurality of shopping mall products sold in the online shopping mall platform, and to request payment, wherein, when the purchaser terminal selects a product in the online shopping mall platform and requests a payment directly or requests a payment after putting the product in the shopping cart, an integrated smart shopping cart icon is displayed on the purchaser terminal screen, and when the integrated smart shopping cart icon is touched or selected by the purchaser terminal, the integrated smart shopping cart app or the integrated smart shopping cart software transmits the selected purchase product information to the integrated smart shopping cart application of the online shopping mall platform server, and wherein when receiving the purchase product information, the integrated smart shopping cart application performs a payment for the purchase product and transmits the performed payment information to the shopping mall server corresponding to the paid product.

According to another aspect of the present invention, the system may further include: a payment right holder terminal equipped with the integrated smart shopping cart app or the integrated smart shopping cart software, wherein, when a product to be purchased in the online shopping mall platform is selected by the purchaser terminal and a payment is requested directly or a payment is requested after the product is put in the shopping cart, in a case where the payment right holder is designated and the integrated smart shopping cart icon displayed on the screen of the purchaser terminal is selected, the payment right holder information and the selected product information are transmitted to the integrated smart shopping cart application of the online shopping mall platform server, and wherein, when receiving the payment right holder information and purchase product information, the integrated smart shopping cart application transmits the purchaser information and purchase product information to the payment right holder terminal, and transmits the payment information to a shopping mall server corresponding to the paid product when the payment for the purchase product for which the payment right holder terminal approves the payment is made.

According to the present invention, even if the user of the online/mobile shopping mall app purchases products from multiple places such as a portal site shopping mall, a collective shopping mall, an individual/specialized shopping mall, an SNS shopping mall, and a telecommunication company affiliated shopping mall, the purchase information is collected, checked, and managed in the integrated smart shopping mall according to the present invention, so that it is possible to enhance convenience of the user.

In addition, a purchase requester such as a minor or a senior can purchase products even if he/she does not subscribe for membership in the online/mobile shopping mall site, so that it is possible to further increase the purchase success rate in the online/mobile shopping mall.

In addition, the payment and delivery information for the purchase product can be shared by purchase the requester such as the minor or the senior, the payment right holder, and the proxy payer, so that it is possible to enhance convenience in the online and mobile shopping malls.

Finally, according to the present invention described above, the integration point can be given to the user after a purchase is made in the integrated smart shopping cart app. For this reason, it is possible to improve the problem that the purchase points cannot be used efficiently because the purchase points acquired by the user upon purchasing the product are distributed in respective online and mobile shopping malls.

### BRIEF DESCRIPTION OF THE DRAWINGS

FIG. 1 is a block diagram showing a hardware system in which an integrated smart shopping cart app according to an embodiment of the present invention is operated.

FIG. 2 is a configuration diagram for explaining an integrated smart shopping cart app operation method according to an embodiment of the present invention.

FIG. 3 is a flow chart for explaining an integrated smart shopping cart app operation method according to an embodiment of the present invention.

FIG. 4 is a block diagram showing a relationship between order, payment, and delivery in an integrated smart shopping cart app operation system according to an embodiment of the present invention.

FIG. 5 is a block diagram showing a communication network connection relationship between a first server, a second server, and a user terminal according to the present invention.

FIG. 6 is a block diagram for explaining an internal configuration of an integrated smart shopping cart system according to the present invention.

FIGS. 7 to 9 are display screens of a terminal showing a method for accessing an integrated smart shopping cart app according to an embodiment of the present invention.

FIG. 10 shows a screen of the integrated smart shopping cart app when an integrated smart shopping cart icon is clicked or touched in FIGS. 7 to 9 to enter the integrated smart shopping cart application.

FIGS. 11 and 12 are terminal display screens showing a method by which a purchase requester selects a purchase product in the integrated smart shopping cart app and selects a payment right holder according to an embodiment of the present invention.

FIGS. 13 to 16 are terminal display screens for explaining a payment process in the integrated smart shopping cart app according to an embodiment of the present invention.

FIG. 17 is a terminal display screen for explaining a payment and delivery process in the integrated smart shopping cart app according to an embodiment of the present invention.

FIGS. 18 and 19 are terminal display screens for explaining a step of subscribing in an unsubscribed online shopping mall in the integrated smart shopping cart app according to an embodiment of the present invention.

FIG. 20 is a configuration diagram for explaining a flow of an integrated smart shopping cart app operation method according to an embodiment of the present invention.

FIG. 21 is a block diagram showing a configuration of an integrated smart shopping cart operation system according to another embodiment of the present invention.

FIG. 22 is a configuration diagram for explaining an integrated smart shopping cart operation system according to another embodiment of the present invention.

FIG. 23 is a flow chart showing an integrated smart shopping cart operation method in an online shopping mall according to another embodiment of the present invention.

FIG. 24 is a configuration diagram showing a relationship between order, payment, and delivery in an integrated smart shopping cart operation system according to another embodiment of the present invention.

FIG. 25 is a block diagram showing detailed functions of an integrated smart shopping cart application of an online shopping mall platform server in an integrated smart shopping cart operation system according to another embodiment of the present invention.

### DETAILED DESCRIPTION

An integrated smart shopping cart operation method according to an aspect of the present invention for integrating and operating a plurality of shopping mall shopping carts when an online/mobile shopping mall app and an integrated smart shopping cart app are installed in a first terminal of a purchase requester, and the integrated smart shopping cart app is installed in a second terminal of a payment right holder, the method including: preparing, in the first server, a driving program of the online/mobile shopping mall app in which an integrated smart shopping cart icon is displayed; preparing, in the second server, an integrated smart shopping cart app driving program connect to the first server to process the integrated smart shopping cart icon; selecting a purchase product by the first terminal of the purchase requester connected to the online/mobile shopping mall app of the first server; activating the integrated smart shopping cart app driving program by activating the integrated smart shopping cart icon on a screen where the purchase product is selected in the first terminal; transmitting, to the second server, purchase product information and payment right holder information selected in the integrated smart shopping cart app of the first terminal; registering, in a database, the purchase product information in the second server; requesting to the second terminal of the payment right holder selected based on the purchase product information by the integrated smart shopping cart app driving program; generating, in the database, purchase information including delivery address information by proceeding a payment based on registered purchase product information by the second terminal of the payment right holder in the integrated smart shopping cart app; transmitting the purchase information and payment information to the online/mobile shopping mall app of the first server by the integrated smart shopping cart app driving program; transmitting delivery information for purchase information to the integrated smart shopping cart app driving program by the driving program of the online/mobile shopping mall app; and checking the payment/delivery information by allowing the first and second terminals to access the integrated smart shopping cart app of the second server.

In order to fully understand the configurations and effects of the present invention, embodiments of the present invention will be described with reference to the accompanying drawings. However, the present invention is not limited to the embodiments disclosed below, and may be embodied in various forms and various modifications may be made. The description of the present embodiments is provided so as to complete the disclosure of the present invention, and is provided to fully inform those of ordinary skill in the art to which the present invention pertains of the scope of the invention.

In the embodiments to be described below, terms such as first, second, and the like may be used to describe various components, but the components are not limited by the terms. The above terms may be used only for the purpose of distinguishing one component from another. The singular expression includes the plural expression unless the context clearly dictates otherwise. For example, terms such as “including” or “having” are intended to designate that a feature, number, step, operation, component, part, or combination thereof described in the specification exists, and includes one or more other features or numbers, steps, operations, components, parts, or combinations thereof may be construed as being added.

Unless defined otherwise, all terms used herein, including technical and scientific terms, have the same meaning as commonly understood by one of ordinary skill in the art to which this invention belongs. Terms such as those defined in commonly used dictionaries are interpreted to have meanings consistent with the meanings in the context of the related art, and are not to be interpreted in an ideal or excessively formal meaning unless explicitly defined in the present application.

As used herein, the term “online shopping mall” includes all online shopping malls such as mobile shopping malls available through an app on a mobile device and general online shopping malls available through the web of a computer, including portal site shopping malls, collective shopping malls, specialized/individual shopping malls, SNS shopping malls where gifts can be given to others, and telecommunication company affiliated shopping malls.

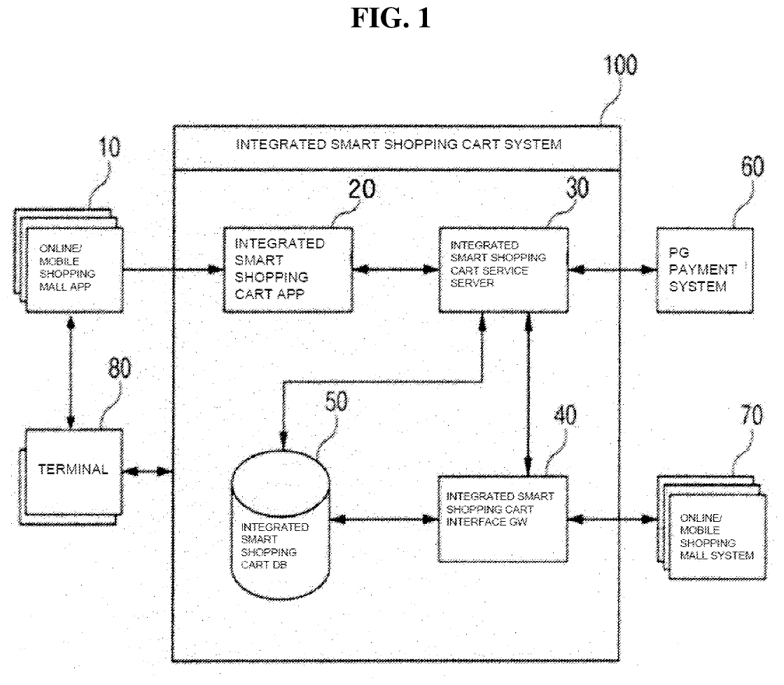

FIG. 1 is a block diagram showing a hardware system in which an integrated smart shopping cart app is operated according to an embodiment of the present invention. Referring to FIG. 1, an integrated smart shopping cart system 100 according to an embodiment of the present invention includes a software module for driving an integrated smart shopping cart app 20 therein, and an integrated smart shopping cart service server 30 in which a software module of the integrated smart shopping cart app 20 is operated.

In addition, the integrated smart shopping cart system 100 may include an integrated smart shopping cart database (DB) 50 therein. Therefore, in the server, various information such as subscriber information, purchase information, and delivery information may be stored in the smart shopping cart database 50 and used directly or by being reprocessed. In addition, the integrated smart shopping cart system 100 includes an integrated smart shopping cart interface gate way (GW) 40 therein. Accordingly, the integrated smart shopping cart system 100 according to the present invention can communicate with an external online/mobile shopping mall system 70 by exchanging various information through the integrated smart shopping cart interface GW 40.

The online/mobile shopping mall system 70 is a site in cyberspace that a user who wants to shop through e-commerce generally accesses through a terminal 80, and may include a necessary hardware system such as a server and a software module for driving an online/mobile shopping mall app, and a database (DB) therein. A PG (payment gateway) payment system 60 is connected to the integrated smart shopping cart service server 30, thereby capable of performing a function of delivering a payment of the cost for shopping by the user to the integrated smart shopping cart system 100, the online/mobile shopping mall system 70, an online/mobile bank, or the like.

The terminal 80 is a hardware device used by the user for shopping, and may be a smartphone, a tablet PC, a personal computer (PC), a smart watch, or the like. Although embodiments of the present invention will be described with a focus on the smart phone, it is possible to access the online/mobile shopping mall app 10 or the integrated smart shopping cart app 20 through the tablet PC, the personal computer, the smart watch, or the like. The online/mobile shopping mall app 10 refers to an application made to be used in the terminal 80 for product sales in the online/mobile shopping mall system 70.

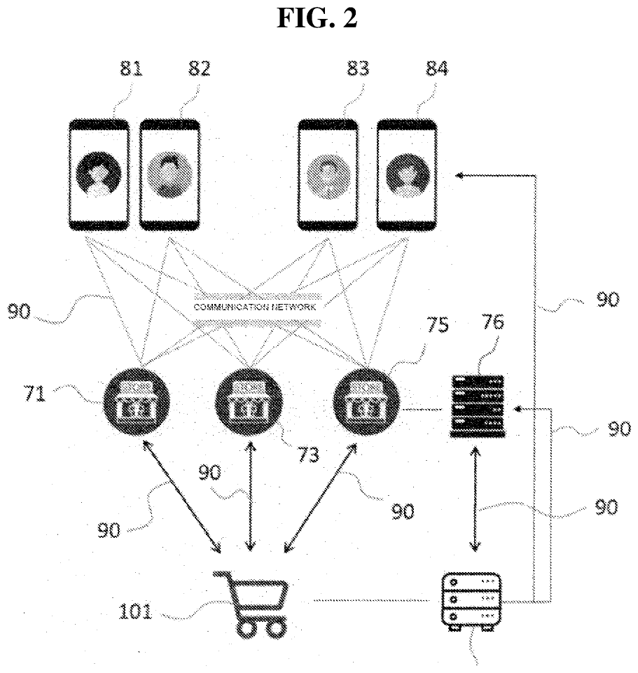

FIG. 2 is a configuration diagram for explaining an integrated smart shopping cart app operation method according to an embodiment of the present invention. Referring to FIG. 2, the use of a terminal 81 is made by a purchase requester of a user type such as a minor including a child and adolescent or a senior who cannot make a payment while using an online/mobile shopping mall site without subscribing in the online/mobile shopping mall site. In the drawing, the use of a terminal 82 is made by a purchase requester of a user type who cannot make a payment while using the online/mobile shopping mall site without subscribing in the online/mobile shopping mall site.

In the drawing, the use of terminals 83 and 84 is made by a payment right holder who can make a payment while using the online/mobile shopping mall site in which the payment right holder has been subscribed or can be subscribed.

The purchase requester selects a product to be purchased through the terminals 81 and 82, and transmits the purchase information to the terminal 83 of the payment right holder via the communication network 90 to purchase the product. In this case, the payment right holder may directly pay for the product requested by the terminals 81 and 82 of the purchase requester through the terminal 83 and for the product that the payment right holder himself/herself wants to purchase, or may pay for the product by the terminal 84 of a proxy payer.

The terminals 83 and 84 of the payment right holder, and the terminals 81 and 82 of the purchase requester may be freely connected to the online/mobile shopping mall apps 71, 73, and 75 having respective servers 76 via the communication network 90 to perform the shopping. The online/mobile shopping mall apps 71, 73, and 75 may be portal site shopping malls such as Daum and Naver, collective shopping malls such as G-Market and home shopping, individual shopping malls that sell individually specialized products, or the like

Meanwhile, in the present embodiment, the online/mobile shopping mall apps 71, 73, and 75, in which the apps are driven, are described to be limited to the portal site shopping malls, the collective shopping malls, and the individual shopping malls. However, it may be self-evident that the online/mobile shopping mall apps 71, 73, and 75 are not limited thereto, and it can be applied, in the same manner described through the embodiments of the present invention below, to all other online/mobile shopping malls that can trade products through e-commerce, such as SNS shopping malls of Kakao Talk that can purchases and gifts the products, and telecommunication company affiliated shopping malls of each telecommunication company that provide mobile communication service. The telecommunication company affiliated shopping malls may include a T-Store of the SK company, family shop shopping of the LG U-Plus company, and the like which are already known in Korea.

An integrated smart shopping cart icon 101, which can be a core of the present invention, is displayed in a pop-up form or a newly generated menu form on a product purchase or shopping cart display screen of the online/mobile shopping mall apps 71, 73, and 75. Then, when the integrated smart shopping cart icon 101 is clicked and activated, all purchase, payment, and delivery information is performed in the integrated smart shopping cart server 30. The integrated smart shopping cart server 30 may communicate with the online/mobile shopping mall app server 76, the purchase requester terminals 81 and 82, and the payment right holder terminals 83 and 84 via the communication network 90.

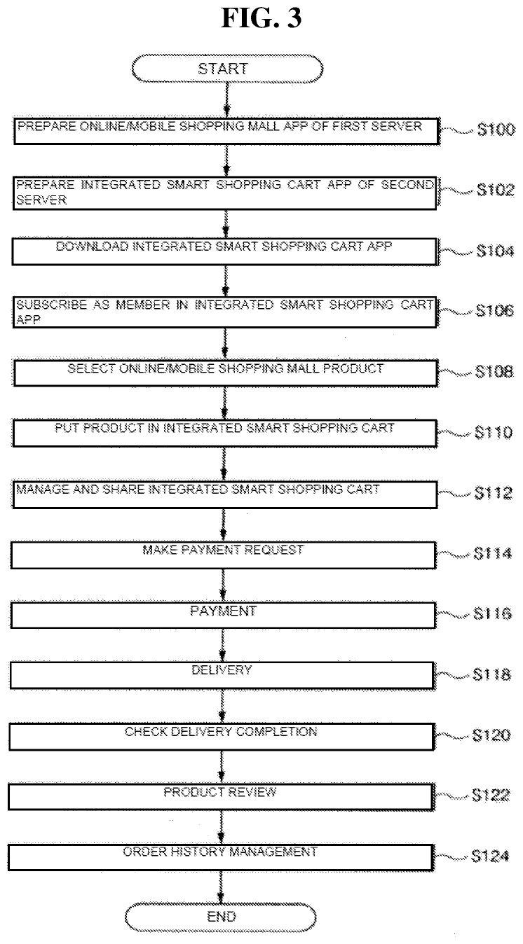

FIG. 3 is a flow chart for explaining an integrated smart shopping cart app operation method according to an embodiment of the present invention. Referring to FIG. 3, a software module, which is a driving program of an online/mobile shopping mall app, is prepared in the first server, for example, each online/mobile shopping mall server (S100). The online/mobile shopping mall app is prepared in various forms to suit the characteristics of each shopping mall, and may be included inside a display screen for purchasing products and a shopping cart display screen where products desired to be purchased can be gathered in one place.

Here, as for the product purchase display screen and/or the shopping cart display screen of the online/mobile shopping mall app, it is suitable for the integrated smart shopping cart icon 101 (FIG. 2) according to the present invention to be displayed in the pop-up form and/or the menu form.

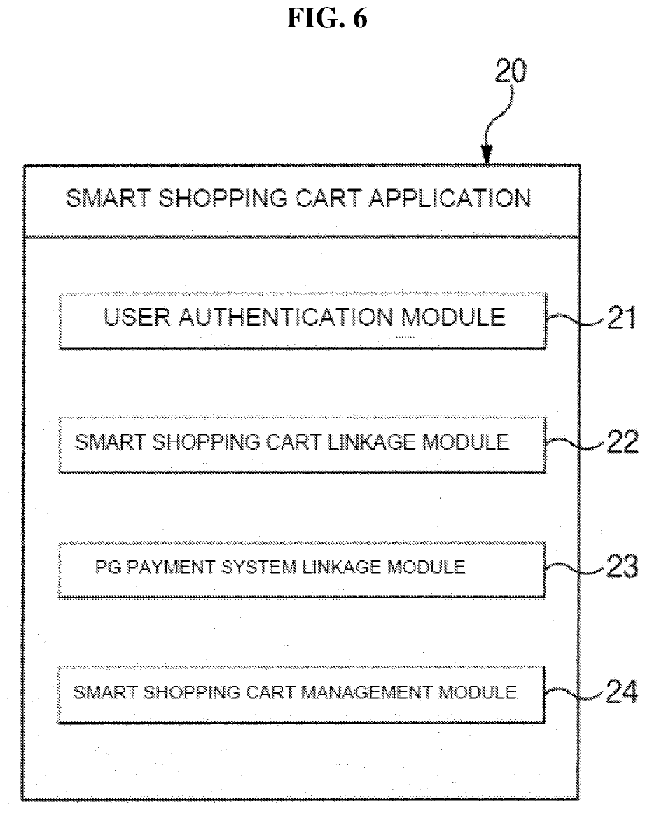

Next, a software module, which is an integrated smart shopping cart app driving program, is prepared in the second server, for example, a server capable of processing the integrated smart shopping cart icon according to the present invention (S102). The software module that is the integrated smart shopping cart app driving program will be described in detail with reference to FIG. 6 that follows.

A user who wishes to purchase a product through the online or mobile shopping mall app downloads the integrated smart shopping cart app (S104). The download of the integrated smart shopping cart app may be arbitrarily selected from a data storage group configured of the company's homepage, Google Play Store, Apple Store, Microsoft Store, and various online/mobile archives where the integrated smart shopping cart app is introduced. In addition, the integrated smart shopping cart app can be downloaded by a link in an SNS message or online and the mobile display screen. In addition, the integrated smart shopping cart app may be classified as an essential app by a terminal vendor and already installed in the terminal at the time of initial sale.

Next, the user of the integrated smart shopping cart app can install the downloaded integrated smart shopping cart app in any one of his/her terminals, such as a smart phone, a tablet PC, a personal computer, and a smart watch, and proceed with membership subscription (S106). In this case, the membership subscription needs to include a step of generating an ID of the user, for example, the purchase requester or the payment right holder and a step of designating the payment right holder for the purchase product among members subscribed in the integrated smart shopping cart app.

At this time, even if the integrated smart shopping cart app is not necessarily subscribed, a modification can be applied in a manner of designating the payment right holder for the purchase product by using a list of phone numbers stored in the terminal which is used by the purchase requester.

The user who has completed installation and membership subscription for the integrated smart shopping cart app according to the present invention accesses the online/mobile shopping mall such as the portal site shopping mall, the collective shopping mall, or the specialized/individual shopping mall, and selects a product the user wants to purchase (S108). In this case, the purchase requester and the payment right holder who are the users may not need to be members of the online/mobile shopping mall app. That is, there is an advantage in that it is not necessary to separately log in to the online/mobile shopping mall app. It is preferable that the selection of the purchase product in the online/mobile shopping mall is performed by the online/mobile shopping mall server which is the first server.

After the selection of the purchase product is made, the user clicks the integrated smart shopping cart icon according to the present invention on the display screen of the purchase product or the shopping cart screen including the purchase product to be activated, and starts the purchase of the product by driving the integrated smart shopping cart app installed in the terminal such as the smart phone of the user. Then, the information of the purchase product in the first server is put in the shopping cart of the integrated smart shopping cart app in the second server (S110). That is, information on the purchase products is transmitted from the corresponding online/mobile shopping mall to the second server capable of processing the integrated smart shopping cart app according to the present invention. Thereafter, the payment for the purchase product may be made by the payment right holder other than the purchase requester in the second server.

Meanwhile, the purchase product information put in the integrated smart shopping cart of the second server may be stored in the database of the second server after validating the purchase product information through communication between the first server and the second server. Accordingly, the purchase product information put in the integrated smart shopping cart is shared and ready to be managed (S112) by the purchase requesters 81 and 82 (FIG. 2) and the payment right holders 83 and 84 (FIG. 2).

Subsequently, the purchase requester makes the payment request (S114) to the payment right holder 83 (FIG. 2) in the first terminals 81 and 82 (FIG. 2). In an embodiment of the present invention, the payment request may be selected by the purchase requester based on an automatic list selected by the purchase requester, and the payment request may be made. However, a modification can be applied in a manner of searching for and requesting the subscriber ID in the integrated smart shopping cart app of the first terminal, or requesting it through the phone number search. In this case, if necessary, the delivery address of the purchase product may also be transmitted to the payment right holder at the same time.

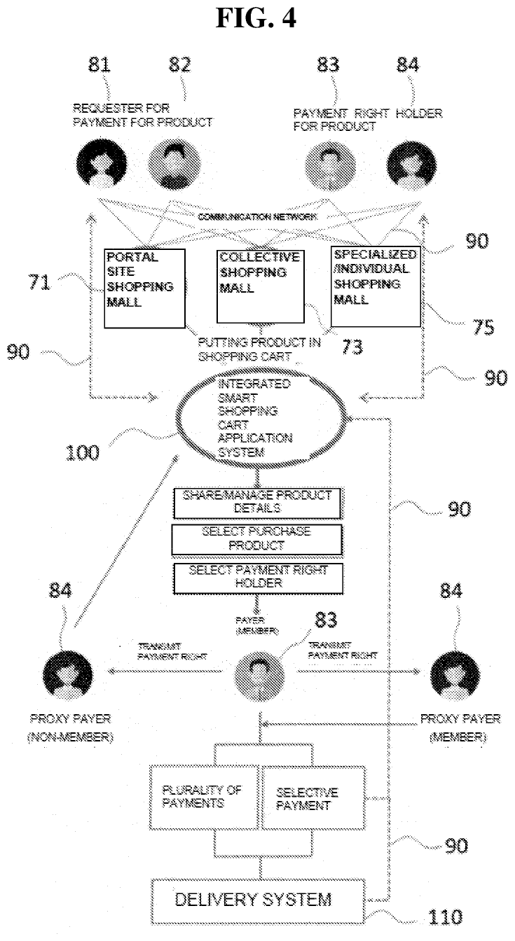

The payment right holder 83 (FIG. 2) checks the purchase information sent by the purchase requester through the second terminal, and then proceeds the payment based on the purchase product information (S116). In this case, the payment right holder may, if necessary, transmit the purchase product information for payment to the proxy payer (see 84 of FIG. 2) to proceed the payment. The payment may be all made at once based on a plurality of product information in the integrated smart shopping cart app according to the present invention, or may be selectively made based on a plurality of product information. This will be described in detail with reference to FIG. 4 that follows.

Here, when the payment (S116) by the payment right holder or the proxy payer is completed, the payment information may be notified to the payment right holder including the purchase requester and the proxy payer. In addition, the second server transmits the purchase information and the payment information to the first server to prepare for delivery of the purchase product in the online/mobile shopping mall of the first server.

When the delivery (S118) of the purchase product in the online/mobile shopping mall driven in the first server is in progress, the purchase/delivery information is transmitted again to the second server, and the purchase requester who is the first terminal user subscribed in the integrated smart shopping cart app driven in the second server, and the payment right holder who is the second terminal user may check and share the delivery information. In this case, the purchase product may be a product selected by the purchase requester, or may be a product selected by the payment right holder himself/herself from the online/mobile shopping mall, if necessary. Therefore, when a child or adolescent who is a minor is the purchase requester and mother or father is the payment right holder or the proxy payer, product purchase in the online/mobile shopping mall can be easily achieved through the integrated smart shopping cart system according to the present invention.

When the delivery of the purchase product is completed, the first and second terminal users receive the purchase product (S120), make a purchase decision, and then can process evaluation (S122) of the purchase product by being connected to the first server through a link in the second server. Finally, the second server may give the payment right holder an integration point paid by the integrated smart shopping cart app. Accordingly, there is a problem in that the purchase points obtained when the user, who is the payment right holder, purchases a product are distributed in respective online and mobile shopping malls, and thereby cannot be used efficiently. However, the present invention has an advantage in that purchase points can be efficiently accumulated and used in one place because payment for all purchase products of the online/mobile shopping malls can be performed in one place.

On the other hand, the companies operating the online/mobile shopping mall app and the integrated smart shopping cart app need to have a mutual agreement in advance on a payment method, a delivery process sharing method, a product evaluation method, a purchase point operation method, and a member management method, or the like to operate the integrated smart shopping cart app according to the present invention. The operation method for the integrated smart shopping cart app according to the present invention can be operated even when the purchase requester and the payment right holder are different from each other, and an autonomous payment method, which can be operated in a case where the purchase requester and the payment right holder are the same person, is selected. The operation method for the integrated smart shopping cart app described above can increase a possibility of a successful purchase by expanding a purchasing base from a child or adolescent who is a minor to a senior in the online/mobile shopping mall that sells actual products. At the same time, it can be said that the use is more advantageous because the purchaser can collect the purchase product information of the distributed online/mobile shopping malls in one place, make a payment in one place, and acquire integrated purchase points.

FIG. 4 is a configuration diagram showing a relationship between the order, the payment, and the delivery in the integrated smart shopping cart app system according to an embodiment of the present invention.

Referring to FIG. 4, the purchase requesters 81 and 82 who are the product payment requesters use the first terminal. The purchase requesters 81 and 82 may not pay as for a child, an adolescent, and a senior, and may not subscribe in the online/mobile shopping mall sites 71, 73, and 75. The payment right holders or the proxy payers 83 and 84 use the second terminal.

The first and second terminal users 81 to 84 have installed the integrated smart shopping cart app according to the present invention and have completed membership subscription. In this case, if necessary, the first and second terminal users 81 to 84 may install the integrated smart shopping cart app and subscribe for the membership through a link included in the message of the purchase requester. In addition, when the purchase requesters 81 and 82 subscribe for the membership, it is preferable that the purchase requester alone can subscribe for the membership, and the designation of the payment right holder 83 is completed.

The first and second terminal users 81 to 84 connect to the online/mobile shopping mall sites 71, 73, and 75 via the communication network 90, select desired purchase products, and then put the purchase information in the integrated smart shopping cart system 100 according to the present invention. The communication network 90 may be a wired/wireless Internet communication network or a mobile wireless data communication network.

The purchase product information stored in the integrated smart shopping cart app system is shared by the first and second terminal users 81 to 84, and the payment right holder 83 is selected by the first terminal users 81 and 82. The payment right holder 83 may additionally designate the member or non-member proxy payer 84 of the online/mobile shopping mall to check the purchase product information, and then allow the proxy payer 84 to make the payment on behalf of the purchaser.

The payment right holders or the proxy payers 83 and 84 may collectively make a plurality of payments for a plurality of purchase products put in the shopping cart of the integrated smart shopping cart app according to the present invention when making the payment. At the same time, the payment right holders or the proxy payers 83 and 84 may select payment for the plurality of purchase products put in the shopping cart of the integrated smart shopping cart app according to the present invention when making the payment.

When the payment for the purchase products by the plurality of payments and the selective payment is completed, each of the online/mobile shopping mall sites 71, 73, and 75 delivers the purchase product through the delivery system 110, and the first and second terminal users 81 to 84 all share detailed delivery information via the communication network 90 through the integrated smart shopping cart app system 100 (FIG. 1) according to the present invention.

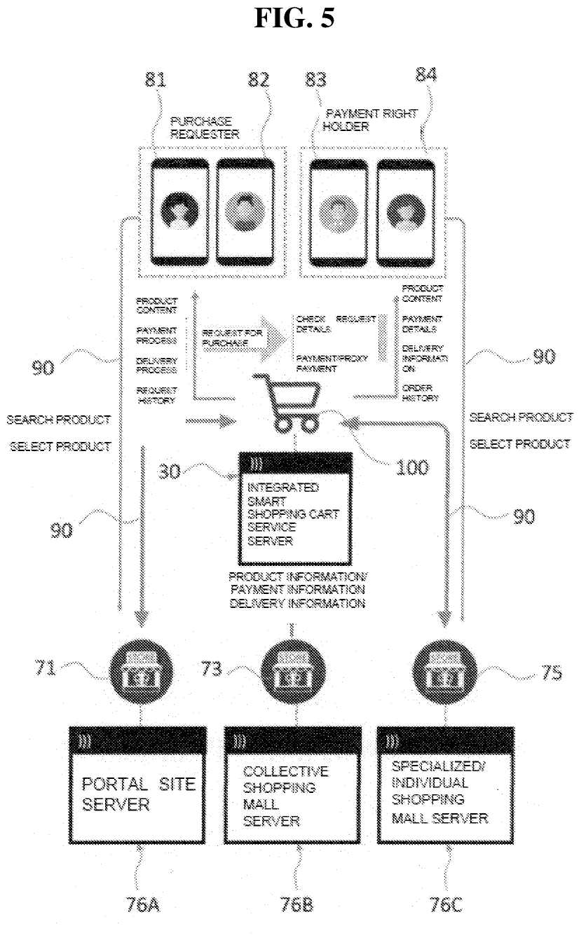

FIG. 5 is a configuration diagram for explaining a connection process between a first server, a second server, and a user terminal according to the present invention.

Referring to FIG. 5, the first servers 76A, 76B, and 76C, in which the online/mobile shopping mall is operated through the app, are connected to the second server 30, in which the integrated smart shopping cart app according to the present invention is operated, via the communication network 90. The purchase product information, the payment information, and the delivery information are transmitted and received via the communication network between the first and second servers 76A to 76C and 30.

In addition, the purchase requesters 81 and 82 using the first terminal and the payment right holders 83 and 84 using the second terminal select the purchase products from the online/mobile shopping mall operated in the first server to put the purchase products in the shopping cart by the second terminal. The first and second terminals 81 to 84, and the second server 30 may share the purchase product information in the shopping cart and also share the payment and delivery information via the communication network 90. In addition, the first and second terminals 81 to 84, and the second server 30 may make the payment request via the communication network 90, check the purchase product information, and transmit and receive the payment details, the delivery information, and the order history information.

Finally, the first and second terminals 81 to 84, and the first servers 76A to 76C transmit and receive information on searching for and selecting the purchase product by the shopping mall user via the communication network 90.

FIG. 6 is a block diagram for explaining an internal configuration of the integrated smart shopping cart system according to the present invention. Referring to FIG. 6, the integrated smart shopping cart app 20 according to the present invention includes a user authentication module 21 for proceeding the membership subscription therein and receiving the user authentication. In addition, the integrated smart shopping cart app 20 includes a smart shopping cart linkage module 22 that can link the purchase product information through the external online/mobile shopping mall app 10 (FIG. 1), and may include a PG payment system linkage module 23 used to proceed the payment of the purchase product and a shopping cart management module 24 for storing and managing registered purchase product information, purchase history information, delivery information, and the like.

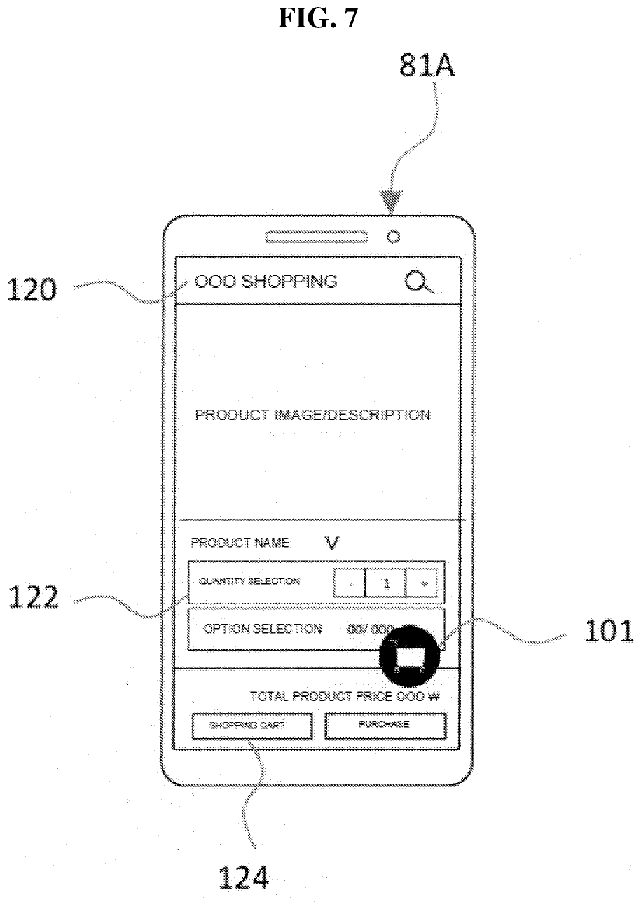

FIGS. 7 to 9 are display screens of a terminal showing a method for accessing the integrated smart shopping cart app according to an embodiment of the present invention. Referring to FIGS. 7 to 9, it shows that the terminal is a display screen 81A of the first terminal, and selection of the purchase product is made by accessing the online/mobile shopping mall app of the first server via a communication network. FIG. 7 shows a first terminal display screen for selecting a product order option 122 while referring to an image and description of the purchase product on the OOO shopping site 120. At this time, on the first terminal display screen, the shopping cart putting and purchase icon 124 through the online/mobile shopping mall app of the first server is displayed at the bottom part. At the same time, an integrated smart shopping cart icon 101 in a form of a pop-up is displayed at a bottom right part.

Therefore, when the first terminal user, for example, the purchase requester, selects a purchase product and completes the product order option 122, and clicks the integrated smart shopping cart icon 101 to activate it, the purchase product information of the OOO shopping site 120 can be transmitted to the second server to be processed.

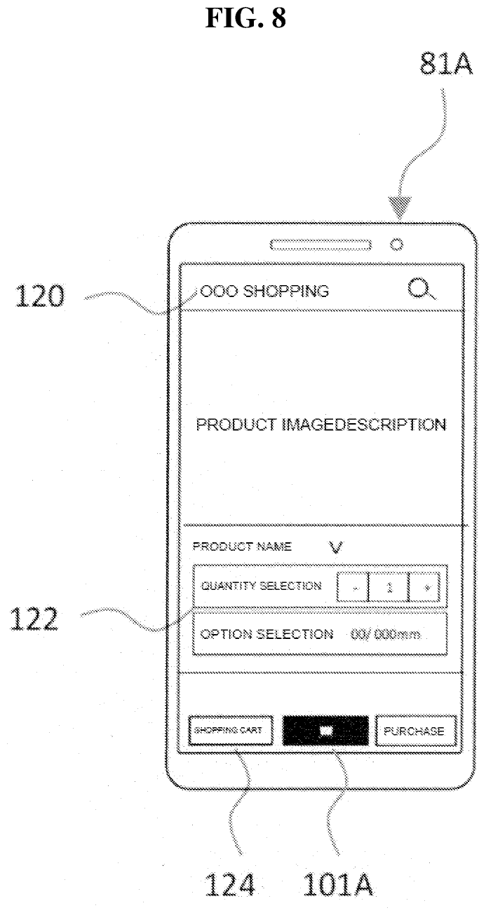

FIG. 8 shows that the integrated smart shopping cart icon 101 of FIG. 7 is provided at the bottom center of the display screen of the first terminal in a form of a bar-shaped menu 101A rather than in a pop-up form. Similarly, when the purchase requester selects a purchase product and completes the product order option 122, and clicks the integrated smart shopping cart icon 101A to be activated in a menu form, the purchase product information of the OOO shopping site 120 can be transmitted to the second server to be processed.

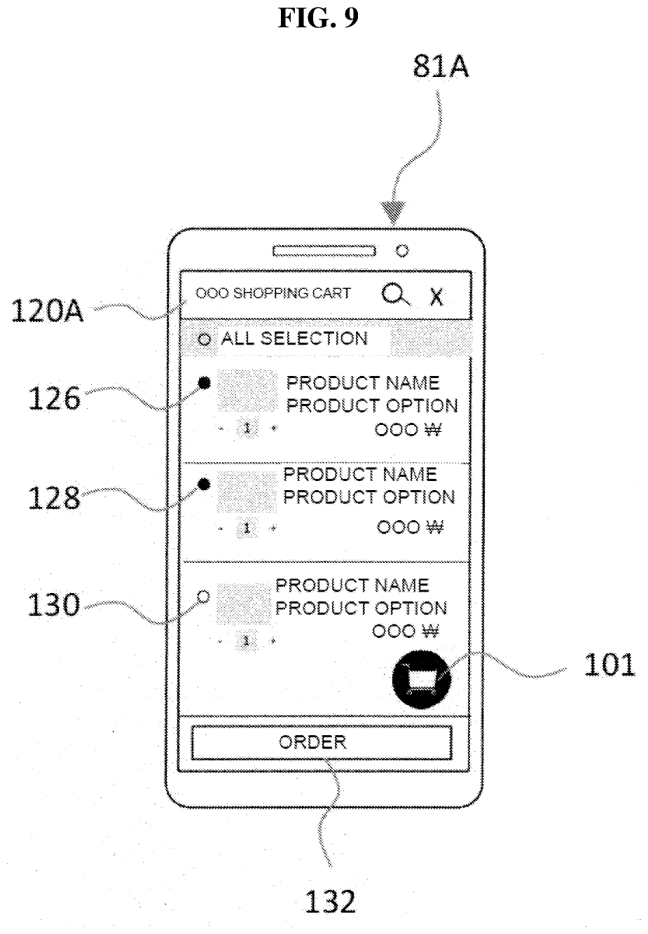

FIG. 9 shows a case in which the integrated smart shopping cart icon 101 is provided in the shopping cart 120A of the OOO shopping site instead of in the product image and description display screen. On the screen, three purchase products are put in the shopping cart. When desired purchase products 126 and 128 are selected in the shopping cart, and the integrated smart shopping cart icon 101 is clicked to be activated, the purchase product information of the OOO shopping site 120A can be transmitted to the second server to be processed. In this case, although the integrated smart shopping cart icon 101 is displayed in the pop-up form, it can be transformed into a screen displayed in a bar-shaped menu form as shown in FIG. 8.

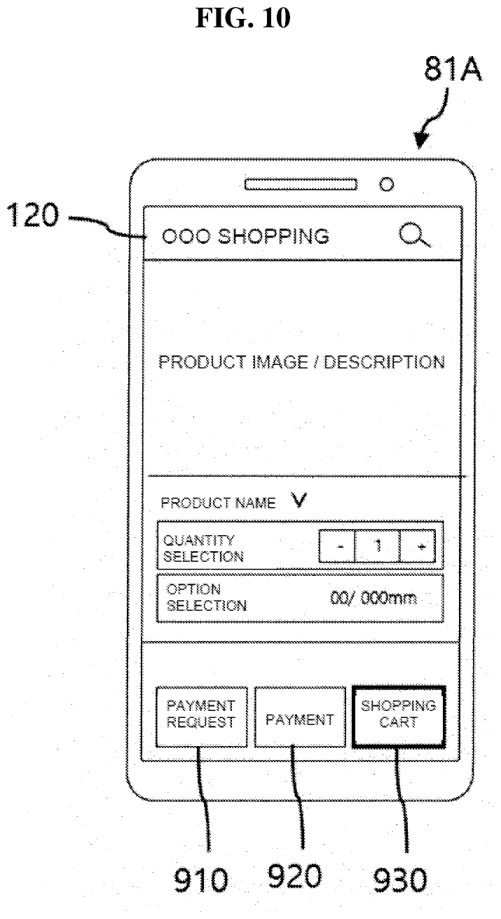

FIG. 10 shows a screen of the integrated smart shopping cart app when the integrated smart shopping cart icon is clicked or touched in FIGS. 7 to 9 to enter the integrated smart shopping cart app. The integrated smart shopping cart app can directly enter payment request 910, payment 920, and shopping cart 930 menus.

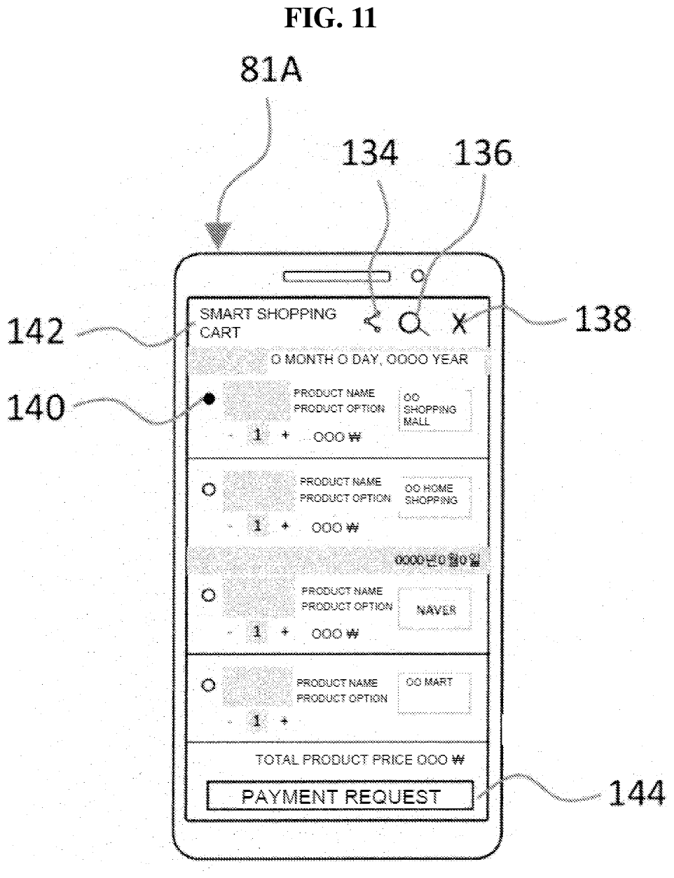

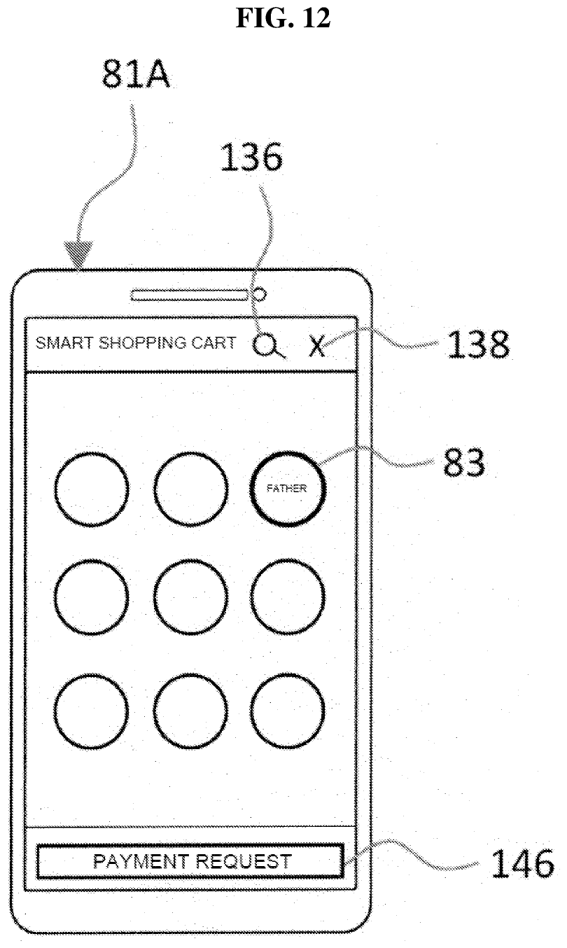

FIGS. 11 and 12 are terminal display screens showing a method by which the purchase requester selects the purchase product in the integrated smart shopping cart app and selects the payment right holder according to an embodiment of the present invention.

Referring to FIGS. 11 and 12, the terminal is the display screen 81A of the first terminal, and it shows that selection of the purchase product is made by accessing the integrated smart shopping cart app according to the present invention of the second server via a communication network.

FIG. 11 shows that the purchase requester using the first terminal selects a final purchase product 140 from the smart shopping cart 142 transmitted to the integrated smart shopping cart app. FIG. 12 shows that the father is designated as the payment right holder 83 after moving to the display screen for designating the payment right holder in a state where the selection of the purchase product is completed. When the payment request icon at the bottom part of the screen is clicked, the purchase product information selected in FIG. 9 is transmitted to the father who is the payment right holder. In the drawing, reference numeral 134 denotes an icon that can share products displayed on the smart shopping cart screen with an arbitrary user, reference numeral 136 denotes a search icon, and reference numeral 138 denotes an icon that can delete the selected purchase product.

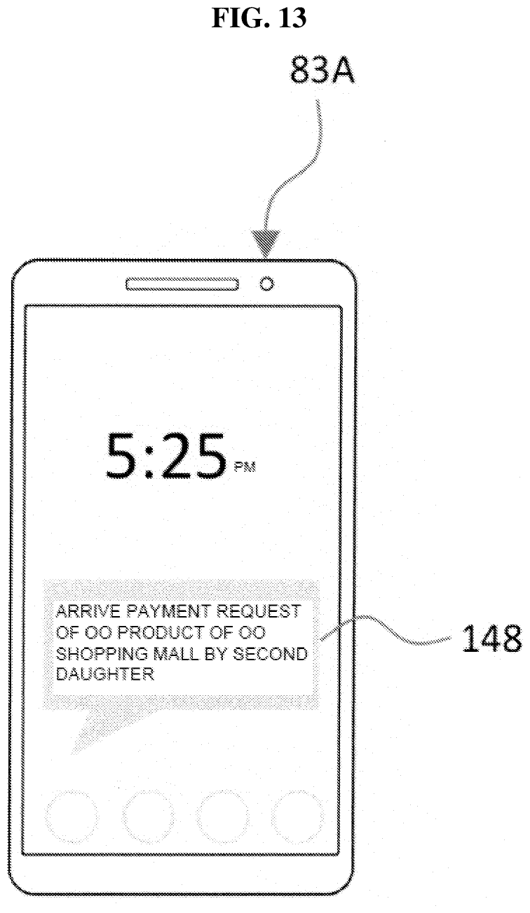

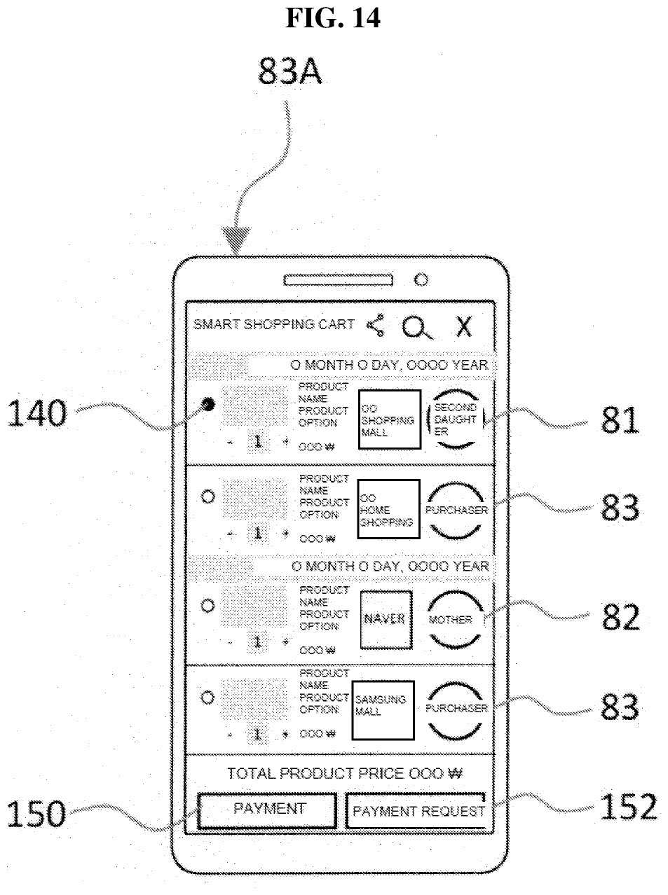

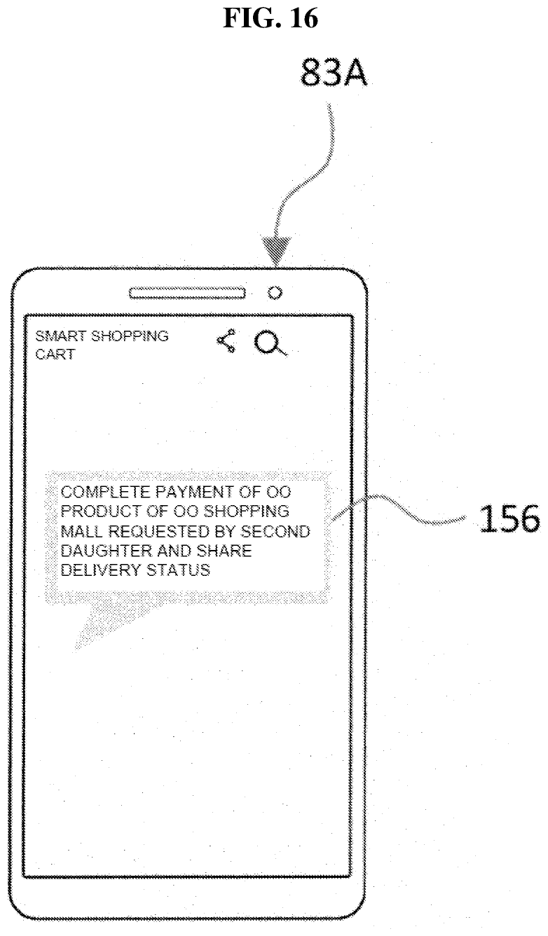

FIGS. 13 to 16 are terminal display screens for explaining a payment process in the integrated smart shopping cart app according to an embodiment of the present invention. FIGS. 13 and 14 show a display screen 83A of the second terminal, and a process of accessing the integrated smart shopping cart app according to the present invention via a communication network. FIG. 13 shows an example of a message 148 in which a payment request is received by the user of the first terminal described with reference to FIGS. 10 to 12. FIG. 14 shows the purchase product information stored in the smart shopping cart of the payment right holder using the second terminal. The purchase product information may be provided by the purchase requesters 81 and 82, and may include purchase product information directly selected by the payment right holder 83. After the purchase product information of the purchase requester 81 is selected as shown in FIG. 13, if the payment icon 150 at the bottom left part of the display screen is clicked, the payment procedure can be proceeded. If the payment right holder 83 clicks the payment request icon 152 at the bottom right part of the display screen of the second terminal in FIG. 14, the proxy payer 84 (FIG. 4) may act on behalf of the payment right holder of the payment of the selected purchase product information 140.

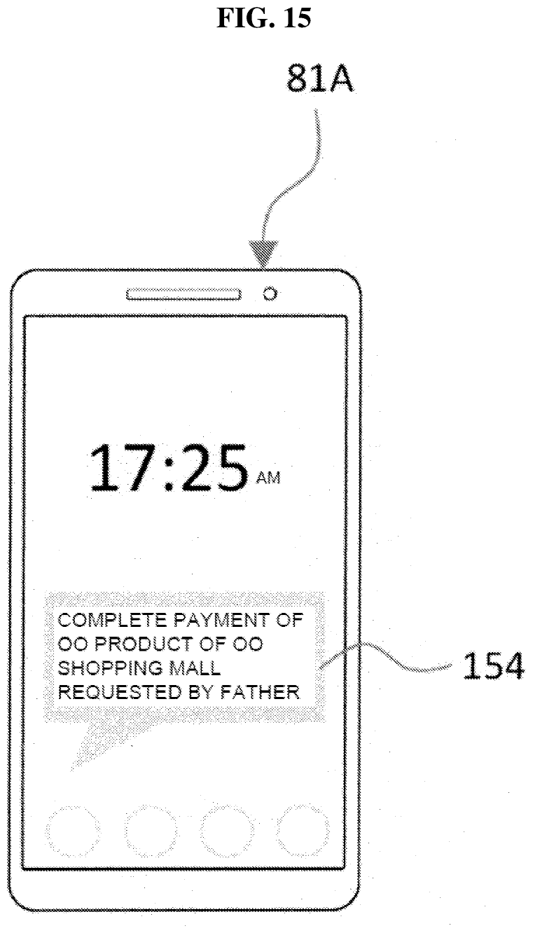

When the payment for the purchase product information is completed by the payment right holder 83, a payment notification message 154 as shown in FIG. 15 is transmitted to the display screen 81A of the first terminal, and a payment message 156 is transmitted to the display screen 83A of the second terminal, so that the payment right holder and the purchase requester can check the payment status for the purchase product. At this time, if the payment right holder 83 requests the payment to the proxy payer, it is appropriate that the payment message be displayed on the display screen of the second terminal 84 (FIG. 2) of the proxy payer.

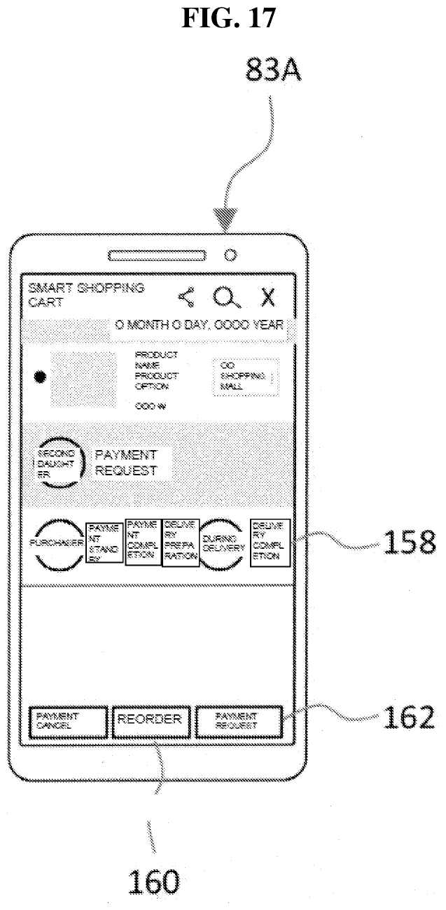

FIG. 17 is a terminal display screen for explaining a payment/delivery process in the integrated smart shopping cart app according to an embodiment of the present invention. Referring to FIG. 17, on the display screen 83A of the second terminal of the payment right holder, the purchase product information selected by a second daughter who is the purchase requester is displayed at the top of the smart shopping cart, and waiting for payment, payment completion, delivery preparation, during delivery, and delivery completion of a delivery step are sequentially displayed in the middle, so that the payment right holder can grasp the delivery information of the purchase product at a glance. At this time, the steps of waiting for payment, payment completion, delivery preparation, during delivery, and delivery completion are described with reference to the display screen 83A of the second terminal of the payment right holder, but it goes without saying that the steps may also be displayed on the display screen 81A of the first terminal of the purchase requester so as to be checked.

If the payment is not made, by clicking the payment request icon 162 at the bottom right part, the proxy payment for the purchase product for which the payment has not been made may be requested to the proxy payer. At the same time, in the case of a purchase product for which payment has been completed, if the payment right holder clicks a reorder icon 160 at the bottom center, the same product reorder and payment for the purchase product displayed on the display screen are made, so that the function of the integrated smart shopping cart app according to the present invention can be further expanded.

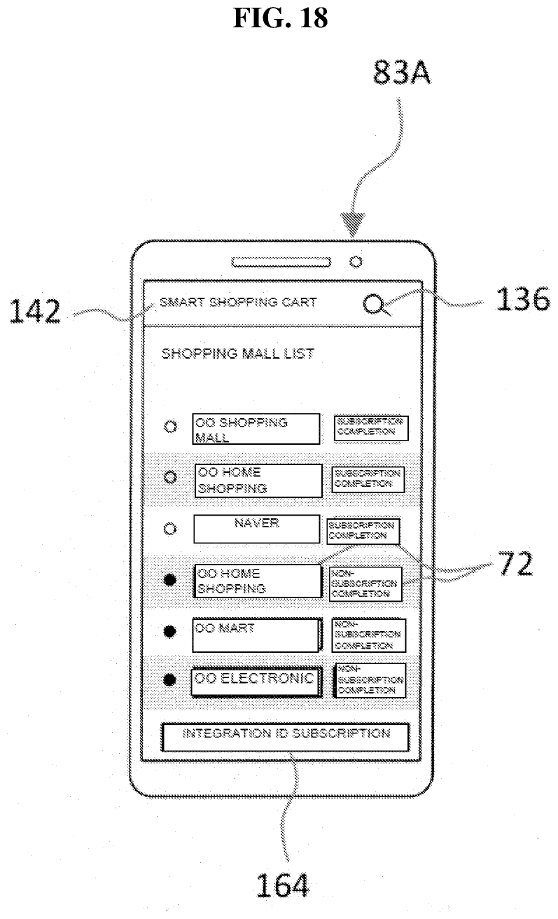

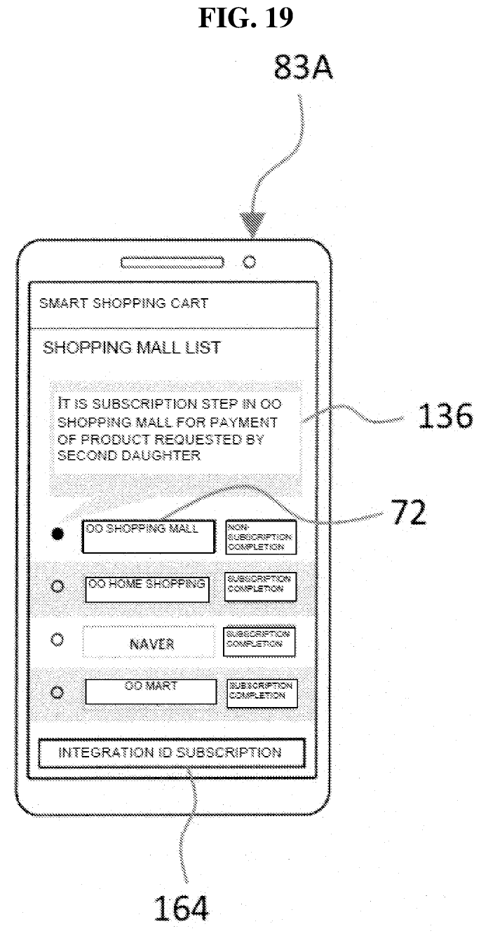

FIGS. 18 and 19 are terminal display screens for explaining a subscription step for an unsubscribed online/mobile shopping mall in the integrated smart shopping cart app according to an embodiment of the present invention.

FIG. 18 shows a case in which an online/mobile shopping mall list compatible with the integrated smart shopping cart app according to the present invention is displayed in the smart shopping cart 142. In this case, a search icon 136 that can provide a search for other online/mobile shopping malls is separately provided at the top right part, so that it is possible to conveniently check whether to become a member of the online/mobile shopping malls. The display screen 83A of the drawing shows the subscription is performed by clicking an integrated ID subscription icon 164 of the integrated smart shopping cart app according to the present invention after selecting three online/mobile shopping malls at the bottom part. At this time, it is also possible to subscribe in a mall by additionally selecting an online/mobile shopping mall 72 that is not subscribed and clicking the integrated ID subscription icon 164 of the integrated smart shopping cart app according to the present invention.

FIG. 19 shows a display screen 83A of the second terminal that appears when it is difficult to purchase a product because the payment right holder does not subscribe in an OO shopping mall according to the purchase product information requested by the purchase requester. In order to solve this problem, the payment right holder selects the unsubscribed online/mobile shopping mall 72, clicks the integrated ID sign-up icon 164 at the bottom part of the display screen 83A to subscribe in the mall, and thereby can proceed to buy the purchase product requested by the purchase requester.

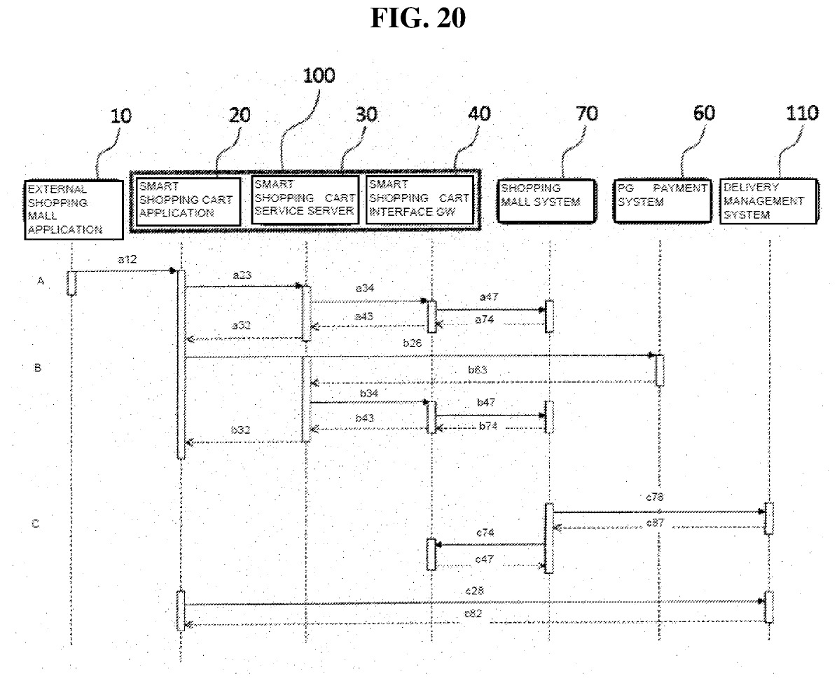

FIG. 20 is a configuration diagram for explaining a flow of an integrated smart shopping cart app operation method according to an embodiment of the present invention.

Referring to FIG. 20, blocks 10 to 110 indicate hardware devices in which the integrated smart shopping cart app operates, and a flow shown by A indicates a process in which the purchase product information is registered in the integrated smart shopping cart system according to the present invention.

The purchase product information is transmitted from the online/mobile shopping mall app 10 corresponding to the external shopping mall application to the integrated smart shopping cart app 20 (a12). In order to check the validity of the received purchase product information, the purchase product information is transmitted to the integrated smart shopping cart service server 30, for example, the second server (a23).

In addition, when an inquiry of detailed information for checking the validity of the purchase product information is requested to the first server of the online/shopping mall system 70 that drives the online/mobile shopping mall app via internal communication (a34) with the smart shopping cart interface GW 40 corresponding to the communication network (a47), and normal responses (a74, a43, and a32) are received, the corresponding purchase product information is stored in the database DB of the integrated smart shopping cart app system according to the present invention.

A flow shown by B in the drawing indicates a payment processing process for the purchase product information registered in the database. Specifically, the payment request for the purchase product information of which the validity has been confirmed is transmitted to the PG payment system 60 (b26). Then, the second server 30 receives the payment result from the PG payment system 60 (b63). Then, the payment information is transmitted (b47) to the online/mobile shopping mall system 70 corresponding to the first server via internal communication (b34) of the integrated smart shopping cart app system 100. Subsequently, the payment result is shared (b74, b43, and b32) in the integrated smart shopping cart app 20 of the integrated smart shopping cart app system 100 according to the present invention. Finally, the payment information for the corresponding purchase product information is stored in the database of the integrated smart shopping cart app system according to the present invention.

A flow shown by C in the drawing indicates a process of changing the status of the purchase product and processing the delivery information for which the payment has been completed. Specifically, the first server displayed as the external shopping mall, for example, the online/mobile shopping mall system, links (c78 and c87) the delivery information of the purchase product to the delivery management system 80. The change of the status of the purchase product scheduled for delivery is made through the integrated smart shopping cart app system 100 via the shopping mall shopping cart interface GW 40 (c47 and c74) in the first server of the online/mobile shopping mall system 70. The integrated smart shopping cart app 20 may inquire (c28) waybill information of the purchase product to the delivery management system 110, and receive a notification (c82) of a result thereof from the integrated smart shopping cart app 20.

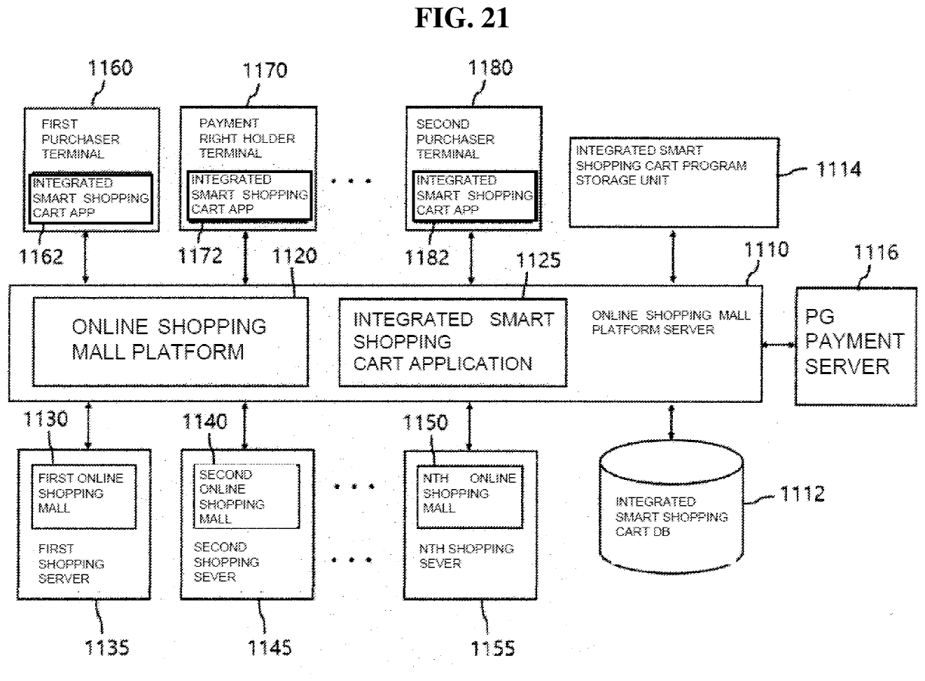

FIG. 21 is a block diagram showing a configuration of an integrated smart shopping cart operation system according to another embodiment of the present invention. Referring to FIG. 21, the integrated smart shopping cart operation system according to another embodiment of the present invention includes an online shopping mall platform 1120, an integrated smart shopping cart application 1125, an online shopping mall platform server 1110, and purchaser terminals 1160 and 1180, and may further include a payment right holder terminal 1170.

The purchaser terminals 1160 and 1180 provide products sold in a plurality of online shopping malls provided by a plurality of online shopping mall servers 1135, 1145, and 1155 in one shopping mall so that the online shopping mall platform 1120 allows the products of the plurality of online shopping malls to be selected and purchased in one place. Also, the online shopping mall platform 1120 can provide a function of an online shopping mall portal that allows the purchaser terminals 1160 and 1180 to access the plurality of online shopping malls 1130, 1140, and 1150 provided by the plurality of shopping mall servers 1135, 1145, and 1155.

The integrated smart shopping cart application 1125 may provide a payment service by integrating payment requests for products purchased by the terminals 1160, 1170, and 1180 on the online shopping mall platform 1120, and is provided by the online shopping mall platform server 1110. That is, when the purchaser terminals 1160 and 1180 select products of a plurality of online shopping malls from the online shopping mall platform 1120 and put them in the integrated smart shopping cart to request payment, even if the products to be paid are from different online shopping malls, they can be integrated and paid. For example, if the purchaser terminals 1160 and 1180 select shoes in Auction shopping mall displayed and the bag in Coupang shopping mall on the online shopping mall platform 1120, put them in the integrated shopping cart, and request payment, the payment is not processed at Auction shopping mall or Coupang shopping mall, and the integrated smart shopping cart application 1125 of the present invention can pay for the shoes in Auction shopping mall and the bag in Coupang shopping mall.

The online shopping mall platform server 1110 provides the online shopping mall platform 1120 and the integrated smart shopping cart application 1125.

The purchaser terminals 1160 and 1180 are terminals for purchasing products of the online shopping malls 1130, 1140, and 1150, which are displayed and sold on the online shopping mall platform 1120. In order to use the integrated payment service provided by the online shopping mall platform server 1110, if the terminal is a mobile device such as a smart phone, the integrated smart shopping cart apps 1162 and 1182 may be installed on the mobile device, and if the terminal is a desktop computer or a laptop computer, the integrated shopping cart software is installed on the desktop computer or the laptop computer.

The purchaser terminals 1160 and 1180 may select products to be purchased from a plurality of online shopping malls 1130, 1140, and 1150 displayed and sold on the online shopping mall platform 1120, and request an integrated payment through the integrated smart shopping cart app or the integrated smart shopping cart software which is equipped therewith. For example, the purchaser terminal 1160 may select at least one shopping mall product among the first online shopping mall 1135 to the nth online shopping mall 1155 displayed and sold on the online shopping mall platform 1120 and immediately request the payment or also request the payment after putting the product in the shopping cart. In this case, the integrated smart shopping cart icon that enables the payment through the integrated smart shopping cart app or the integrated smart shopping cart software may be displayed on the screens of the purchaser terminals 1160 and 1180. The integrated smart shopping cart icon may be displayed on the terminal screen as the pop-up icon.

When the purchaser terminals 1160 and 1180 pay for the selected products in the online shopping mall, if the integrated smart shopping cart icon displayed on the screens of the purchaser terminals 1160 and 1180 is touched or clicked, the selected purchase product information is transmitted to the online shopping mall platform server 1110, that is, to the integrated smart shopping cart application 1125.

When receiving the purchase product information from the integrated smart shopping cart apps 1162 and 1182, the integrated smart shopping cart application 1125 makes the payment for the purchase product and transmits the performed payment information to the shopping mall server corresponding to the paid product. For example, if the paid product is a product of the first online shopping mall 1130, the payment information of the paid product is transmitted to the first shopping mall server 1135.

Meanwhile, the integrated smart shopping cart operation system according to another embodiment of the present invention may further include a payment right holder terminal 1170. The payment right holder terminal 1170 may be equipped with the integrated smart shopping cart app or the integrated smart shopping cart software.

The purchaser terminals 1160 and 1180 may select at least one shopping mall product displayed and sold on the online shopping mall platform 1120, and request the payment directly or request the payment after putting the product in the shopping cart. In this case, the purchaser may request the payment to the payment right holder without directly paying. For example, a daughter who is a minor, as a purchaser, may purchase her product from a shopping mall and request the payment to her father who is the payment right holder.

When the purchaser terminals 1160 and 1180 select products to be purchased on the online shopping mall platform 1120 and then immediately make the payment, or when the products in the shopping cart are paid after putting the selected products in the shopping cart, the purchaser terminals 1160 and 1180 designate the payment right holder, and when the integrated smart shopping cart icon displayed on the screens of the purchaser terminals 1160 and 1180 is selected by clicking or touching the icon, the designated payment right holder information and the selected product information are transmitted to the integrated smart shopping cart application 1125.

When the integrated smart shopping cart application 1125 provided by the online shopping mall platform server 1110 receives the payment right holder information and the purchase product information transmitted from the integrated smart shopping cart app or the integrated smart shopping cart software equipped in the purchaser terminals 1160 and 1180, the purchaser information and the purchase product information are transmitted to the payment right holder terminal 1170.

The payment right holder terminal 1170 may receive the purchaser information and the purchase product information from the online shopping mall platform server 1110, and proceed the payment for all of the purchase products or approve only some of the purchase products in response to the payment request of the purchaser to proceed with the payment when there are a plurality of purchase products. Alternatively, the payment right holder may designate the proxy payer to make the payment.

When the payment is made through the online shopping mall platform server 1110 for the purchase product for which the payment right holder terminal 1170 has approved the payment, the online shopping mall platform server 1110 transmits the payment information to the shopping mall server corresponding to the paid product. In addition, the online shopping mall platform server 1110 may transmit the payment information to the integrated smart shopping cart apps 1162, 1172, and 1182 equipped in the purchaser terminals 1160 and 1180, and the payment right holder terminal 1170.

When receiving the payment information for the products sold in the corresponding shopping mall from the online shopping mall platform server 1110, the shopping mall servers 1135, 1145, and 1155 deliver the paid products, and the delivery information may be transmitted to the purchaser terminals 1160 and 1180, and the payment right holder terminal 1170. Also, when the payment for the purchase product is made, the online shopping mall platform server 1110 may provide an integrated point to the purchaser or the payment right holder who makes the payment.

Meanwhile, the online shopping mall platform server 1110 may include an integrated smart shopping cart database (DB) 1112. The online shopping mall platform server 1110 may store various information such as the subscriber information, the purchase information, and the delivery information in the integrated smart shopping cart DB 1112 and use them directly or after being reprocessed.

The shopping mall servers 1135, 1145, and 1155 are online shopping mall systems, which may include a necessary hardware system such as a server therein as a site in cyberspace that users who want to shop through e-commerce generally access through the terminals 1160, 1170, and 1180, a software module for driving the online shopping mall application, a database (DB), and the like. In addition, the PG (payment gateway) payment system 1116 may be connected to the online shopping mall platform server 1110 to make the payment for the product purchased by the purchaser or the payment right holder through online/mobile payment means or the like.

The terminals 1160, 1170, and 1180 are hardware devices used by a user for shopping, and may be a smartphone, a tablet PC, a personal computer, a smart watch, or the like. In particular, the smart phone may be equipped with the integrated smart shopping cart app. The present invention describes the embodiments focusing on the smart phone. However, the terminals 1160, 1170, and 1180 may be connected to the integrated smart shopping cart application 1125 by driving the integrated smart shopping cart apps 1162, 1172, and 1182 equipped in the tablet PC, the personal computer, and the smart watch, purchase products of the online shopping malls 1130, 1140, and 1150 in the online shopping mall platform 1120, and access the shopping mall servers 1135, 1145, and 1155 to view more detailed product items.

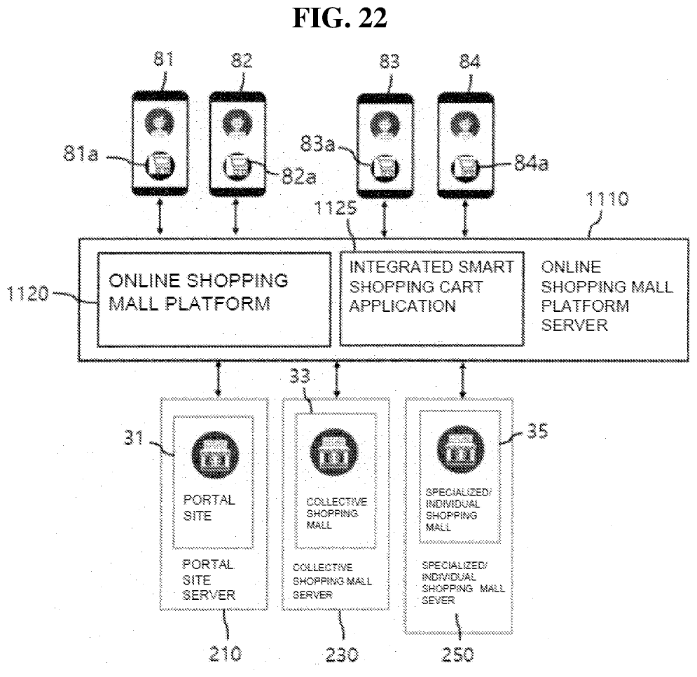

FIG. 22 is a configuration diagram for explaining an integrated smart shopping cart operation system according to another embodiment of the present invention. Referring to FIG. 2, the use of the terminal 81 is made by the purchase requester of a user type such as a minor including a child and adolescent or a senior who cannot make a payment while using the online/mobile shopping mall site without subscribing in the online/mobile shopping mall site. In the drawing, the terminal 82 may be used by a purchase requester who does not pay while using the online/mobile shopping mall site regardless of whether he or she subscribes in the online/mobile shopping mall site.

In the drawing, the terminals 83 and 84 may be used by the payment right holder who has been subscribed in, or can subscribe in the online/mobile shopping mall site and can make the payment while using the online/mobile shopping mall site.

The terminals 81 and 82 of the purchase requester may be connected to the integrated smart shopping cart application 1125 by touching or clicking the integrated smart shopping cart icon displayed on the screen. The terminals 81 and 82 of the purchase requester may select a plurality of online shopping mall products in the online shopping mall platform 1120, and send the purchase information to the terminal 83 of the payment right holder through the integrated smart shopping cart application 1125 to purchase the products. The integrated smart shopping cart application 1125 integrates, in one place, the products of the portal site shopping mall 31, the collective shopping mall 33, and the specialized/individual shopping mall 35 where the terminals 81 and 82 shop in the online shopping mall platform 1120 to provide the payment service, and is provided by the online shopping mall platform server 1110.

At this time, the payment right holder directly pays for the product requested from the terminals 81 and 82 of the purchase requester and the product that the payment right holder himself/herself wants to purchase through the terminal 83, either directly or through the terminal 84 of the proxy payer.

The terminals 83 and 84 of the payment right holder and the terminals 81 and 82 of the purchase requester may connect to the online shopping mall platform 1120 and shop the products of the online/mobile shopping malls 31, 33, and 35 displayed and sold on the online shopping mall platform 1120. The online/mobile shopping malls 31, 33, and 35 are provided by respective servers 210, 230, and 250, and may be the portal site shopping mall 31 such as Daum and Naver, the collective shopping mall 33 such as G-Market, or home shopping, and the individual shopping mall 35 that sells a specific product alone or specialized.

Referring to FIG. 22, the shopping mall servers 210, 230, and 250 operating the online/mobile shopping malls 31, 33, and 35 may be connected to the online shopping mall platform server 1110 that provides the integrated smart shopping cart application 1125 according to the present invention through the online shopping mall platform 1120. The shopping mall servers 210, 230, and 250 may transmit and receive the purchase product information, the payment information, and the delivery information through the integrated smart shopping cart application 1125 provided by the online shopping mall platform server 1110.

In addition, the purchasers 81 and 82 using the first terminal and the payment right holders 83 and 84 using the second terminal may select the purchase product on the online shopping mall platform 1120 and put the purchase product in the shopping cart through the shopping cart application 1125 of the online shopping mall platform server 1110. The first and second terminals 81 to 84, and the online shopping mall platform server 1110 may share information on the purchase products in the shopping cart and also share the payment and delivery information through the integrated smart shopping cart application 1125. In addition, the first and second terminals 81 to 84 may make the payment request through the integrated smart shopping cart application 1125 associated with the integrated smart shopping cart app, check the purchase product information, and the payment details, and the delivery information, and the order history information are transmitted and received. In addition, the first and second terminals 81 to 84 and the shopping mall servers 210, 230, and 250 may transmit and receive information on searching for the purchase product and selection of the purchase product by the shopping mall user through the smart shopping cart application 1125.

Meanwhile, in the present embodiment, the online/mobile shopping malls 31, 33, and 35 are limited to the portal site shopping mall, the collective shopping mall, and the individual shopping mall, but the online/mobile shopping malls 31, 33, and 35 are not limited thereto. It may be self-evident that the same method described through the embodiments of the present invention can be applied to all other types of online/mobile shopping malls that can trade products through e-commerce, such as SNS shopping malls such as Kakao Talk that can purchase and gift the product, and telecommunication company affiliated shopping malls of each telecommunication company providing mobile communication service. The telecommunication company affiliated shopping mall may include T-Store of the SK company and the family shop shopping of the LG U-Plus company, which are already known in Korea.

When paying products of the online/mobile shopping malls 31, 33, and 35 displayed and sold on the online shopping mall platform 1120 or putting them in the integrated shopping cart, the integrated smart shopping cart icon provided by the embodiment of the present invention may be displayed in the pop-up form or a newly generated menu form. In addition, when the integrated smart shopping cart icon is touched or clicked, the purchase, payment, and delivery information may be integrated, collected, and managed by the integrated smart shopping cart application 1125 of the online shopping mall platform server 1110. The integrated smart shopping cart application 1125 may transmit and receive information to and from the online shopping mall servers 210, 230, and 250, the purchase requester terminals 81 and 82, and the payment right holder terminals 83 and 84.

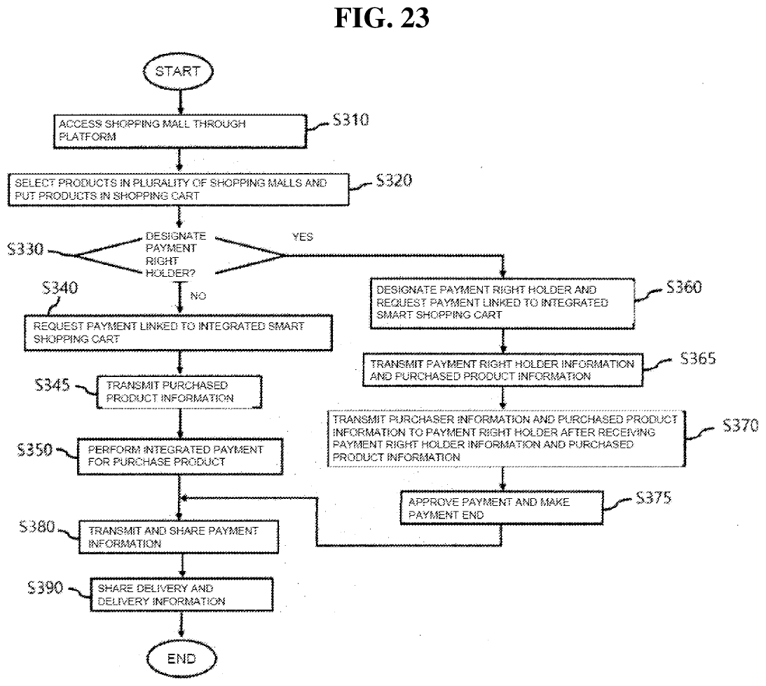

FIG. 23 is a flow chart showing an integrated smart shopping cart operation method in an online shopping mall according to another embodiment of the present invention. The integrated smart shopping cart operation method in the online shopping mall according to another embodiment of the present invention will be described with reference to FIGS. 21 to 23.

The online shopping mall platform 1120 and the integrated smart shopping cart application 1125 are provided by the online shopping mall platform server 1110. The purchaser terminals 1160 and 1180 provide products, which are sold by a plurality of online shopping malls provided by a plurality of online shopping mall servers 1135, 1145, and 1155 in one shopping mall, so that the online shopping mall platform 1120 may select and purchase the products sold in a plurality of online shopping malls in one place.

The integrated smart shopping cart application 1125 may provide the payment service by integrating the payment requests for the products purchased by the terminals 1160, 1170, and 1180 on the online shopping mall platform 1120. That is, when the purchaser terminals 1160 and 1180 select products of a plurality of online shopping malls in the online shopping mall platform 1120 and put them in the integrated smart shopping cart to request the payment, even if the products to be paid are provided from different online shopping malls, they can be paid by integrating them.

The purchaser terminal may select products sold in the plurality of online shopping malls each provided by the plurality of shopping mall servers in the online shopping mall platform 1120 and request the payment.

The online shopping mall platform 1120 may be prepared in various forms to suit the characteristics of each shopping mall, and may be included therein on the display screen for product purchase and the shopping cart display screen for collecting products desired to purchase in one place. Here, when purchasing the product in the online shopping mall platform 1120 or putting the product in the shopping cart, the integrated smart shopping cart icon according to the present invention may be displayed in the pop-up form and/or the menu form on the screen of the purchaser terminal.

A terminal where a product is desired to be purchased through the online shopping mall platform 1120 may download the integrated smart shopping cart app or integrated smart shopping cart software stored in an integrated smart shopping cart program storage unit 1114 of the online shopping mall platform server 1110. The download of the integrated smart shopping cart app or the integrated smart shopping cart software may be performed by arbitrarily selecting from the company's homepage, Google Play Store, Apple Store, Microsoft Store, and a data storage group configured of various online/mobile archives where the integrated smart shopping cart app or the integrated smart shopping cart software is introduced. In addition, the integrated smart shopping cart app or the integrated smart shopping cart software may be downloaded through a link in an SNS message or online and mobile display screens. In addition, the integrated smart shopping cart app may be classified as an essential app by a terminal vendor and already installed in the terminal at the time of initial sale.

The user of the integrated smart shopping cart app or the integrated smart shopping cart software may install the downloaded integrated smart shopping cart app or the integrated smart shopping cart software on any one of his/her terminals, such as the smart phone, the tablet PC, the personal computer, and the smart watch to proceed the membership subscription. In this case, the member subscription may include steps of generating an ID of the user, for example, the purchase requester or the payment right holder, and designating the payment right holder from among members subscribed in the integrated smart shopping cart app. At this time, even if the integrated smart shopping cart app is not necessarily subscribed, a modification can be applied in a manner of designating the payment right holder for the purchase product by using a list of phone numbers stored in the terminal used by the purchase requester.

The purchaser terminals 1160, 1180, 81, and 82 equipped with the integrated smart shopping cart app or the integrated smart shopping cart software access the online shopping mall platform 1120 (S310).

The purchaser terminals 1160, 1180, 81, and 82 select products of at least one of the shopping malls 1130, 1140, 1150, 31, 33, and 35 displayed and sold on the online shopping mall platform 1120 and immediately make the payment, or put the products in the integrated shopping cart (S320).

A user who has completed the installation and the membership subscription for the integrated smart shopping cart app or the integrated smart shopping cart software according to the present invention may select products of the online/mobile shopping mall such as the portal site shopping mall, the collective shopping mall, or the specialized/individual shopping mall displayed and sold on the online shopping mall platform 1120. In this case, the purchase requester who is the user and the payment right holder does not need to be a member of the online/mobile shopping mall. That is, there is an advantage in that it is not necessary to separately log into the online/mobile shopping mall.

In addition, after the selection of the purchase product is made, the purchaser terminal touches or clicks the integrated smart shopping cart icon according to the present invention on the display screen of the purchase product or the shopping cart screen including the purchase product, so that the integrated smart shopping cart application 1125 linked to the integrated smart shopping cart app installed in the terminal such as the purchaser's smart phone operates. Then, information on the purchase product in the online shopping mall platform 1120 is put in the shopping cart of the integrated smart shopping cart application 1125 in the online shopping mall platform server 1110. That is, the information on the purchase product is transmitted to the online shopping mall platform server 1110 that can process the integrated smart shopping cart in the corresponding online shopping mall.

After that, when paying for the purchase product, the purchaser himself/herself may pay directly, or may designate the payment right holder and request the payment to the payment right holder. The payment for the purchase product may be performed by the payment right holder other than the purchase requester in the online shopping mall platform server 1110.

That is, it is checked whether to designate the payment right holder in order to pay for the product to be purchased (S330) and when the purchaser directly pays the product without designating the payment right holder, the payment is requested by allowing the integrated smart shopping cart app equipped in the purchaser terminal to link to the integrated smart shopping cart application 1125 (S340). The linkage between the integrated smart shopping cart app and the integrated smart shopping cart application 1125, when the payment is requested, can be done by clicking or touching the integrated smart shopping cart icon displayed on the individual product display screen of the shopping mall provided by the shopping mall server. The purchase product information selected in the integrated smart shopping cart app is transmitted to the integrated smart shopping cart application 1125 of the online shopping mall platform server 1110 that provides the online shopping mall platform 1120 (S345). The online shopping mall platform server 1110 performs the payment for the purchase product upon receiving the purchase product information (S350).

On the other hand, when payment is made by selecting the purchase product or when payment is made after the selected product is put in the shopping cart, the payment right holder may be designated (S330). In a case of the payment by requesting the payment to the payment right holder, after the purchaser terminal selects at least one shopping mall product or puts the selected product in the shopping cart, in a state where the payment right holder is designated or has already been designated, the payment is requested for the selected product through the integrated smart shopping cart app or the integrated smart shopping cart application 1125 associated with the integrated smart shopping cart software (S360). The association between the integrated smart shopping cart app and the integrated smart shopping cart application 1125 when the payment is requested may be performed by clicking or touching the integrated smart shopping cart icon displayed on the individual product display screen of the shopping mall provided by the shopping mall server. The payment right holder information and the selected purchase product information selected by the integrated smart shopping cart app of the purchaser terminal are transmitted to the online shopping mall platform server 1110 (S365).

Then, when receiving the payment right holder information and the purchase product information, the online shopping mall platform server 1110 transmits the purchaser information and the purchase product information to the payment right holder terminal equipped with the integrated smart shopping cart app or integrated smart shopping cart software (S370). The payment right holder terminal receives the payment request for the purchaser information and the purchase product information through the integrated smart shopping cart app, accepts the payment, and makes the payment for the purchase product corresponding to the payment approval of the payment right holder terminal (S375) In this case, when receiving the payment request for a plurality of purchase products from the online shopping mall platform server 1110, the payment right holder terminal may accept only a part of the payment for the plurality of purchase products, or designate the proxy payer.

On the other hand, when the payment for the purchase product is made (S350 and S375), the online shopping mall platform server 1110 may provide the integration point to the purchaser or the payment right holder who has made the payment. In addition, after the payment is made (S350 and S375), the online shopping mall platform server 1110 may transmit the payment information to the shopping mall server corresponding to the paid product, and transmit the payment information to the integrated smart shopping carts equipped in the purchaser terminal and the payment right holder terminal to share the payment information (S380).

When the shopping mall server receives the payment information for the purchase product from the online shopping mall platform server 1110 in step S380, the delivery of the purchase product is processed, and the delivery information may be transmitted to the integrated shopping cart app equipped in the purchaser terminal and the payment right holder terminal (S390).

Meanwhile, the purchaser terminal selects the integrated smart shopping cart icon and links the product selected on the individual product display screen of the online shopping mall platform 1120 to the integrated smart shopping cart app, and then the personal information may be shared with a member of the integrated smart shopping cart app who allows the information disclosure together with the purchase product information. In addition, product information including product reviews, ID, region, gender, and age information left by the purchaser of the purchaser terminal after the product purchase is confirmed in the integrated smart shopping cart app may be registered by being divided in a purchase list for each product on the integrated smart shopping cart app screen.

When the above-described payment request, the payment, and the delivery process are described in more detail, the purchase product information put in the integrated smart shopping cart of the online shopping mall platform server 1110 may be confirmed through communication between the shopping mall servers 1135, 1145, 1155, 210, 230, and 250, and the online shopping mall platform server 1110, and then stored in the database 1112 of the online shopping mall platform server 1110.

Accordingly, the purchase product information put in the integrated smart shopping cart is ready to be shared and managed by the purchase requesters 81 and 82 (FIG. 22), and the payment right holders 83 and 84 (FIG. 22).

Subsequently, the purchase requester makes the payment request to the payment right holder 83 (FIG. 22) in his/her first terminals 81 and 82 (FIG. 22). In another embodiment of the present invention, the payment request may be selected by the purchase requester based on an automatic list selected by the purchase requester and the payment request may be made. However, a modification can be applied in a manner of requesting the payment by searching the subscriber ID in the integrated smart shopping cart app of the first terminals 81 and 82 (FIG. 22), or requesting the payment by searching a phone number. In this case, if necessary, the delivery address of the purchase product may also be transmitted to the payment right holder at the same time.

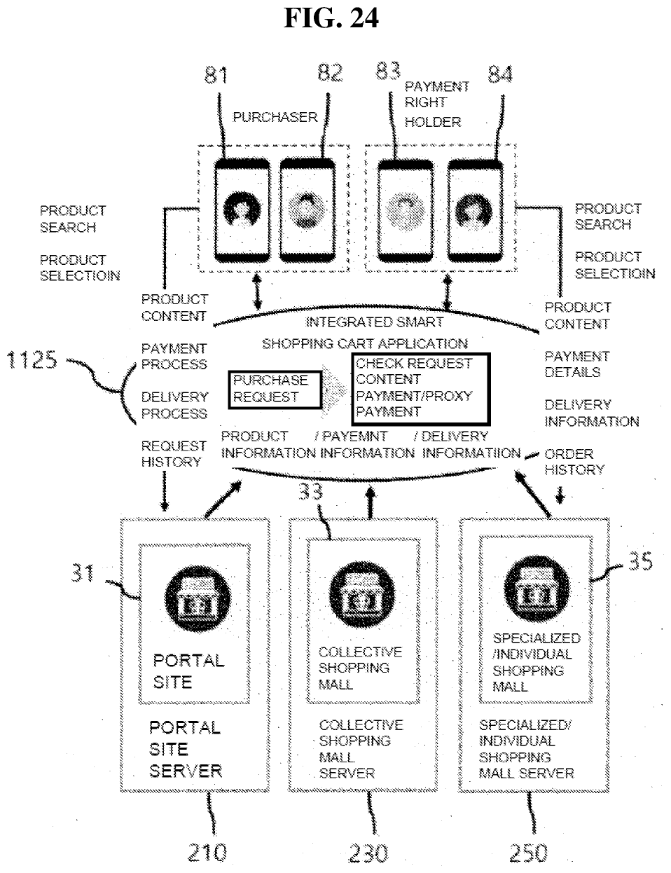

The payment right holder checks the purchase information sent by the purchase requester through the second terminal 83 (FIG. 2), and then proceeds the payment based on the purchase product information. In this case, if necessary, the payment right holder may transmit the purchase product information for the payment to the proxy payer terminal 84 (FIG. 22) to proceed the payment. The payment may be all made at once based on a plurality of product information in the integrated smart shopping cart app according to the present invention, or may be selectively made based on a plurality of product information. This will be described in detail with reference to FIG. 24 that follows.

Here, when the payment by the payment right holder or the proxy payer is completed, the payment information may be notified to the payment right holder including the purchase requester and the proxy payer. In addition, the online shopping mall platform server 1110 transmits the purchase information and the payment information to the shopping mall server to prepare for the delivery of the purchase product in the online/mobile shopping mall of the shopping mall server.

When the delivery of the purchase product is proceeded in the online/mobile shopping mall in which the shopping mall server is driven, the purchase/delivery information is transmitted again to the online shopping mall platform server 1110, and the purchase requester who is the first terminal user and the payment right holder who is the second terminal user subscribed in the smart shopping cart app driven in the online shopping mall platform server 1110 may check and share the delivery information. In this case, the purchase product may be a product selected by the purchase requester, or may be a product selected by the payment right holder himself/herself in the online/mobile shopping mall, if necessary. Therefore, when a child or adolescent who is a minor is the purchase requester, and the mother or the father is the payment right holder or the proxy payer, the product purchase in the online/mobile shopping mall can be easily achieved through the integrated smart shopping cart system according to the present invention.

When the delivery of the purchase product is completed, the first and second terminal users may receive the purchase product, make a purchase decision, and then proceed the evaluation of the purchase product in the online shopping mall platform server 1110 by being connected to the shopping mall server through a link. Finally, the online shopping mall platform server 1110 may give the payment right holder the integration point paid by the integrated smart shopping cart app. Conventionally, there is a problem in that the purchase point obtained when the payment right holder who is the user purchases the product is distributed in respective online and mobile shopping malls, and thus the purchase point cannot be used efficiently. However, the present invention has an advantage in that purchase points can be efficiently accumulated and used in one place because the payment for all purchase products of the online/mobile shopping malls can be made in one place.

On the other hand, for the companies operating the online/mobile shopping mall app and the integrated smart shopping cart app, there is a need for mutual agreement in advance on the payment method, the delivery process sharing method, the product evaluation method, the purchase point operation method, the member management method, and the like to operate the integrated smart shopping cart app according to the present invention. The operation method for the integrated smart shopping cart app according to the present invention can be operated even when the purchase requester and the payment right holder are different from each other, and an autonomous payment method that can be operated for the same person as each other is selected. The operation method for the integrated smart shopping cart app described above can increase a possibility of a successful purchase by expanding the purchasing base to a child or adolescent who is a minor, and a senior in the online/mobile shopping mall that sells the actual products. At the same time, it can be said that the use of the method is more advantageous because the purchaser can collect the purchase product information of the distributed online/mobile shopping mall in one place, make the payment in one place, and acquire the integrated purchase points.

FIG. 24 is a block diagram showing a relationship between the order, the payment, and the delivery in the integrated smart shopping cart operation system according to another embodiment of the present invention. Referring to FIG. 24, the purchase requesters 81 and 82 who are the product payment requesters use the first terminal. The purchase requesters 81 and 82 may not make the payment such as a child or adolescent who is a minor, and a senior, and may not subscribe in the online/mobile shopping malls 31, 33, and 35. The payment right holders or the proxy payers 83 and 84 use the second terminal.

The first and second terminal users 81, 82, 83, and 84 have installed the integrated smart shopping cart app according to the present invention and have completed the membership subscription. In this case, if necessary, the first and second terminal users 81, 82, 83, and 84 may install the integrated smart shopping cart app and subscribe for the membership through a link included in the message of the purchase requester. In addition, when the purchase requesters 81 and 82 subscribe for the membership, the purchase requester alone can subscribe, and it is preferable that the designation of the payment right holder 83 has completed.

The first and second terminal users 81, 82, 83, and 84 access the online shopping mall platform and select products of the online/mobile shopping malls 31, 33, and 35 displayed and sold on the online shopping mall platform, and then put the purchase information in the integrated smart shopping cart according to the present invention. The online shopping mall can be accessed via a wired/wireless Internet communication network or a mobile wireless data communication network.

The purchase product information stored in the integrated smart shopping cart application 1125 is shared by the first and second terminal users 81, 82, 83, and 84, and the payment right holder 83 is selected by the first terminal users 81 and 82. The payment right holder 83 may additionally designate the member or non-member proxy payer 84 of the online/mobile shopping mall to confirm the purchase product information, and then allow the proxy payer 84 to make the payment on behalf of the purchaser.

The payment right holders or the proxy payers 83 and 84 may collectively make a plurality of payments for a plurality of purchase products put in the shopping cart of the integrated smart shopping cart app according to the present invention when making the payment. At the same time, the payment right holders or the proxy payers 83 and 84 may select the payment for the plurality of purchase products put in the shopping cart of the integrated smart shopping cart app according to the present invention when making the payment.

When the payment of the cost for the purchase product by the plurality of payment and the selective payment is completed, each of the online/mobile shopping malls 31, 33, and 35 delivers the purchase product through the delivery system, and the first and second terminal users 81 to 84 share detailed delivery information through the integrated smart shopping cart app by the online shopping mall platform server 1110 according to the present invention.

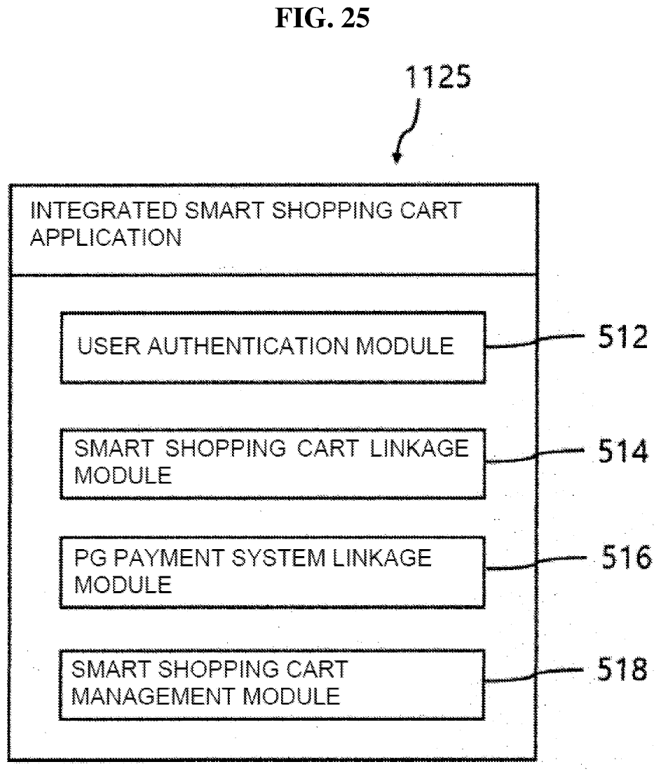

FIG. 25 is a block diagram showing a detailed configuration of the integrated smart shopping cart application 1125 of the online shopping mall platform server 1110 in the integrated smart shopping cart operation system according to another embodiment of the present invention. Referring to FIG. 25, the integrated smart shopping cart application 1125 according to the present invention includes a user authentication module 512 for proceeding the membership subscription therein and receiving the user authentication. In addition, the integrated smart shopping cart application 1125 includes a smart shopping cart linkage module 514 capable of linking the product information purchased in a plurality of shopping malls, and may include a PG payment system linkage module 516 used to proceed the payment for the purchase product. and a smart shopping cart management module 518 for storing and managing registered purchase product information, purchase history information, delivery information, and the like.

FIGS. 7, 8, and 9 show the display screens of the terminal indicating the method for accessing the integrated smart shopping cart application in the integrated smart shopping cart operation method and system according to another embodiment of the present invention. FIG. 10 shows the screen of the integrated smart shopping cart app when the integrated smart shopping cart icon is clicked or touched to enter the integrated smart shopping cart application in the integrated smart shopping cart operation method and system according to another embodiment of the present invention.

FIGS. 11 and 12 show the method by which the purchase requester selects the purchase product in the integrated smart shopping cart app and selects the payment right holder in the integrated smart shopping cart operation method and system according to another embodiment of the present invention. FIGS. 13 to 15 show the terminal display screens for explaining the payment process in the integrated smart shopping cart application in the integrated smart shopping cart operation method and system according to another embodiment of the present invention.

FIG. 17 shows the terminal display screen for explaining the payment and delivery process in the integrated smart shopping cart application in the integrated smart shopping cart operation method and system according to another embodiment of the present invention. FIGS. 18 and 19 show the terminal display screens for explaining the step of subscribing for an unsubscribed online/mobile shopping mall in the integrated smart shopping cart app in the integrated smart shopping cart operation method and system according to another embodiment of the present invention.

The description of FIGS. 7 to 19 for explaining the integrated smart shopping cart operation method and system according to another embodiment of the present invention are the same as those of the above-described embodiment of the present invention, and thus a more detailed description will be omitted.

Although the present invention has been described with reference to the embodiments shown in the drawings, which are merely exemplary, those of ordinary skill in the art will understand that various modifications and equivalent other embodiments are possible therefrom. Accordingly, the true scope of protection of the present invention should be defined only by the appended claims.

The present invention can be used for online e-commerce using a terminal including a mobile device.

1. A method of operating an integrated smart shopping cart for integrating and operating a plurality of shopping mall shopping carts when an online/mobile shopping mall app and an integrated smart shopping cart app are installed in a first terminal of a purchase requester, and the integrated smart shopping cart app is installed in a second terminal of a payment right holder, the method comprising:
preparing a driving program of the online/mobile shopping mall app in which an integrated smart shopping cart icon is displayed, in a first server;
preparing an integrated smart shopping cart app driving program which connects to the first server to process the integrated smart shopping cart icon, in a second server;
selecting a purchase product by the first terminal of the purchase requester connected to the online/mobile shopping mall app of the first server;
activating the integrated smart shopping cart app driving program by activating the integrated smart shopping cart icon on a screen where the purchase product is selected in the first terminal;
transmitting, to the second server, purchase product information and payment right holder information selected in the integrated smart shopping cart app of the first terminal;
registering the purchase product information in a database of the second server;
requesting, by the integrated smart shopping cart app driving program, to make a payment to the second terminal of the payment right holder selected based on the purchase product information;
proceeding, by the second terminal of the payment right holder, a payment based on the registered purchase product information in the integrated smart shopping cart app to generate purchase information including delivery address information in the database;
transmitting, by the integrated smart shopping cart app driving program, the purchase information and payment information to the online/mobile shopping mall app of the first server;
transmitting, by the driving program of the online/mobile shopping mall app, delivery information for purchase information to the integrated smart shopping cart app driving program; and
accessing, by the first and second terminals, to the integrated smart shopping cart app of the second server to check the payment/delivery information.

2. The method of claim 1,
wherein a method of displaying the integrated smart shopping cart icon in the online/mobile shopping mall app of the first server is one of methods selected from an icon form on an integrated smart shopping cart that pops up on the display screen for product purchase and a menu form on an integrated smart shopping cart newly generated on the display screen for purchase.

3. The method of claim 1,
wherein the first terminal of the purchase requester is in a state where the integrated smart shopping cart app is installed and membership subscription is completed.

4. The method of claim 3,
wherein a method for subscribing as a member of the integrated smart shopping cart app includes
generating an ID of a product purchaser who is the purchase requester; and
designating a payment right holder for a purchase product from among members subscribed in the integrated smart shopping cart app or designating a payment right holder for the purchase product by using a portable phone number stored in the first terminal.

5. The method of claim 1,
wherein a method for activating the integrated smart shopping cart icon includes clicking an integrated smart shopping cart icon on an individual product display screen of the online/mobile shopping mall of the first server.

6. The method of claim 1, further comprising:
designating, by the payment right holder, a proxy payer in the integrated smart shopping cart app before the step of proceeding the payment based on the registered purchase information by the payment right holder using the second terminal.

7. The method of claim 1,
wherein a method of proceeding, by the payment right holder using the second terminal, the payment based on the registered purchase information includes making the payment selectively or all at once based on the purchase product information selected by the purchase requester and the purchase information directly selected by the payment right holder.

8. The method of claim 1, further comprising:
proceeding a purchase decision procedure in the integrated smart shopping cart app, after the step of accessing, by the first and second terminals, to the integrated smart shopping cart app of the second server to check the payment/delivery information; and
providing an integration point for the payment right holder in the integrated smart shopping cart app.

9. A system of operating an integrated smart shopping cart, the system comprising:
a plurality of first servers providing shopping mall service;
a second server providing payment service by integrating payment requests for products purchased in the plurality of shopping mall servers; and
a purchaser terminal which is equipped with an integrated smart shopping cart app, is configured to be able to access the plurality of first servers, and is configured to request a payment by selecting products to be purchased in the plurality of shopping malls,
wherein, when at least one product to be purchased is selected in at least one shopping mall and the integrated smart shopping cart app is activated for payment, the integrated shopping cart app transmits, to the second server, payment right holder information input from a user or preset payment right holder information, and purchase product information on at least one selected product, and
wherein, when receiving the payment right holder information and the purchase product information, the second server transmits the purchase product information to the payment right holder terminal to request a payment, and when the payment is made by the payment right holder terminal approving the payment, payment information for the purchase product information is transmitted to the first server corresponding to the paid product and the integrated smart shopping cart app.

10. The system of claim 9,
wherein, when receiving the payment information for the paid product from the second server, the first server transmits delivery information for the paid product to the integrated smart shopping cart app.

11. A method of operating an integrated smart shopping cart in an online shopping mall, the method comprising:
providing an online shopping mall platform, by an online shopping mall platform server which is configured to select, in one shopping mall, products sold in a plurality of online shopping malls respectively provided by a plurality of shopping mall servers and request a payment thereof;
accessing, by a purchaser terminal, the online shopping mall platform;
displaying an integrated smart shopping cart icon on a purchaser terminal screen when the purchaser terminal selects and pays for at least one product in the online shopping mall platform;
transmitting purchase product information to be paid to the online shopping mall platform server when an integrated shopping cart icon displayed on the terminal screen is touched or clicked upon payment; and
making a payment for the purchase product and transmitting payment information to a shopping mall server corresponding to the paid product when the online shopping mall platform server receives the purchase product information.

12. The method of claim 11, further comprising:
requesting an integrated payment to the online shopping mall platform server for the selected products by designating a payment right holder for the selected product or in a state where a payment right holder has already been designated, when the purchaser terminal selects a product to be purchased in the online shopping mall platform and touches or clicks an integrated smart shopping cart icon displayed on a terminal screen to pay directly or pay after putting the product in the shopping cart;
transmitting the purchaser information and purchase product information to the payment right holder terminal when the online shopping mall platform server receives the payment right holder information and the purchase product information;
receiving, by the payment right holder terminal, a payment request for the purchaser information and the purchase product information and approving a payment; and
transmitting, by the online shopping mall platform server, the payment information to a shopping mall server corresponding to the paid product when payment for the purchase product corresponding to the payment approval by the payment right holder terminal is made.

13. The method of claim 12,
wherein, when receiving a payment request for a plurality of purchase products from the online shopping mall platform server, the payment right holder terminal approves only a part of the payment for the plurality of purchase products, or designates a proxy payer.

14. The method of claim 12,
wherein, when payment for the purchase product is made, the online shopping mall platform server transmits the payment information to an integrated smart shopping cart app equipped in the purchaser terminal and the payment right holder terminal.

15. The method of claim 11, further comprising:
proceeding a delivery of the purchase product and transmitting delivery information to the integrated smart shopping cart app equipped in the purchaser terminal and the payment right holder terminal when the shopping mall server receives payment information for the purchase product from the online shopping mall platform server.

16. The method of claim 11, further comprising:
providing an integrated point to the purchaser or payment right holder who has made the payment by the online shopping mall platform server when the payment for the purchase product is made.

17. The method of claim 11,
wherein the purchaser terminal selects the integrated smart shopping cart icon and links the product selected in the online shopping mall platform to the integrated smart shopping cart app, and then personal information is shared along with the purchase product information for the integrated smart shopping cart app member who permits information disclosure.

18. The method of claim 11,
wherein, after product purchase is confirmed in the integrated smart shopping cart app, product information including product reviews, ID, region, gender, and age information left by the purchaser of the purchase terminal is classified and registered as a purchase list for each product on an integrated smart shopping cart app screen.

19. A system of operating an integrated smart shopping cart, the system comprising:
an online shopping mall platform configured to select and purchase, in one shopping mall, products sold in a plurality of online shopping malls provided by a plurality of online shopping mall servers;
an integrated smart shopping cart application that provides payment service by integrating payment requests for a plurality of shopping mall products selected in the online shopping mall platform;
an online shopping mall platform server that provides the online shopping mall platform and the integrated smart shopping cart application; and
a purchaser terminal configured to be equipped with an integrated smart shopping cart app or installed with integrated smart shopping cart software, to access the online shopping mall platform through the integrated smart shopping cart app or the integrated smart shopping cart software, to select a plurality of shopping mall products sold in the online shopping mall platform, and to request payment,
wherein, when the purchaser terminal selects a product in the online shopping mall platform and requests a payment directly or requests a payment after putting the product in the shopping cart, an integrated smart shopping cart icon is displayed on the purchaser terminal screen, and when the integrated smart shopping cart icon is touched or selected by the purchaser terminal, the integrated smart shopping cart app or the integrated smart shopping cart software transmits the selected purchase product information to the integrated smart shopping cart application of the online shopping mall platform server, and
wherein when receiving the purchase product information, the integrated smart shopping cart application performs a payment for the purchase product and transmits the performed payment information to the shopping mall server corresponding to the paid product.

20. The system of claim 19, further comprising:
a payment right holder terminal equipped with the integrated smart shopping cart app or the integrated smart shopping cart software,
wherein, when a product to be purchased in the online shopping mall platform is selected by the purchaser terminal and a payment is requested directly or a payment is requested after the product is put in the shopping cart, in a case where the payment right holder is designated and the integrated smart shopping cart icon displayed on the screen of the purchaser terminal is selected, the payment right holder information and the selected product information are transmitted to the integrated smart shopping cart application of the online shopping mall platform server, and
wherein, when receiving the payment right holder information and purchase product information, the integrated smart shopping cart application transmits the purchaser information and purchase product information to the payment right holder terminal, and transmits the payment information to a shopping mall server corresponding to the paid product when the payment for the purchase product for which the payment right holder terminal approves the payment is made.
